(19) United States
(12) Patent Application Publication
(10) Pub. No.: US 2023/0186308 A1
(43) Pub. Date: Jun. 15, 2023

(54) UTILIZING A FRAUD PREDICTION MACHINE-LEARNING MODEL TO INTELLIGENTLY GENERATE FRAUD PREDICTIONS FOR NETWORK TRANSACTIONS

(71) Applicant: Chime Financial, Inc., San Francisco, CA (US)

(72) Inventor: Jiby Babu, Austin, TX (US)

(21) Appl. No.: 17/546,410

(22) Filed: Dec. 9, 2021

(51) Int. Cl. G06Q 20/40

(52) U.S. Cl. CPC G06Q 20/4016; G06Q 20/40145; G06Q 20/4015

(57) ABSTRACT

The present disclosure relates to systems, non-transitory computer-readable media, and methods that predicts in real time (or near real time) whether an initiated network transaction is fraudulent based on a machine-learning model that intelligently weights features associated with the initiated network transaction. For example, in less than a hundred millisecond latency, the fraud detection system can determine an initiated network transaction is fraudulent based on device metadata, historical transactions, and/or other feature families. To illustrate, in one or more embodiments, the fraud detection system uses various IP distances between devices (e.g., at certain times) associated with a sender account and/or a recipient account to determine whether a given network transaction is fraudulent. By utilizing a machine-learning model to analyze these and other features, the fraud detection system can intelligently adapt to new fraud schemes, changes to fraud algorithms, and guard the network security of various network transactions in real time.

### BACKGROUND

As online transactions have increased in recent years, network-transaction-security systems have increasingly used computational models to detect and protect against cyber fraud, cyber theft, or other network security threats that compromise encrypted or otherwise sensitive information. For example, as such network security risks have increased, existing network-transaction-security systems have employed more sophisticated computing models to detect security risks affecting transactions, account balances, personal identity information, and other information over computer networks that use computing device applications. In peer-to-peer (P2P) network transactions, for instance, these security risks can take the form of collusion, fake account take over, or fraudulently represented (or fraudulently obtained) credentials. Exacerbating these issues, hackers have become more sophisticated—in some cases to the point of mimicking the characteristics of authentic network transactions detected or flagged by existing computational models.

In view of the foregoing complexities, conventional network-transaction-security systems have proven inaccurate—often misidentifying fraud or failing to detect fraud. Indeed, conventional network-transaction-security systems often fail to intelligently differentiate between true positive and false positive fraudulent network transactions. For instance, because hackers try to simulate the features of an authorized or legitimate transaction, computing systems that apply rigid computing models (e.g., heuristics) often cannot detect the difference between fraudulent and non-fraudulent features.

Similarly, these conventional computing models cannot consistently identify fraud as corresponding to one class of fraud versus another class of fraud. To illustrate, conventional computing models cannot accurately differentiate between first-party fraud of a fake-account-take over versus an actual hack or other network security compromising action for an account take over that results in an unauthorized P2P transaction. Without more granular identification capabilities, conventional network-transaction-security systems perpetuate inaccuracies of fraudulent transaction identification (e.g., as evident by false negative and/or false positive fraud values).

### BRIEF SUMMARY

This disclosure describes embodiments of systems, non-transitory computer-readable media, and methods that solve one or more of the foregoing problems in the art or provide other benefits described herein. In particular, the disclosed systems utilize a fraud prediction machine-learning model to predict whether a peer-to-peer (P2P) network transaction or other network transaction is fraudulent. For instance, the disclosed systems can receive a request to initiate a network transaction between a sender account and a recipient account and identify one or more features associated with the network transaction. Such features may include device information, send/receive transaction history, transaction-based features, etc. From one or more features, the fraud prediction machine-learning model generates a fraud prediction. To illustrate, the disclosed systems can implement a random forest machine-learning model to generate a binary fraud prediction or a fraud prediction score based on one or more weighted features.

Upon generating a fraud prediction, the disclosed systems can suspend the network transaction to facilitate verification processes. Based on the verification processes, the disclosed systems can then approve or deny the network transaction. In some cases, the disclosed systems also suspend a network account (and/or an associated network transaction). By implementing a feedback loop, the disclosed systems can also identify the network transaction as a true positive if the network transaction results in a network account suspension or if the network transaction corresponds to a fraud-claim reimbursement.

By utilizing a fraud detection machine-learning model, the disclosed systems can improve the accuracy of detecting or predicting fraudulent P2P or other network transactions. As described further below, the disclosed systems can accordingly improve the speed and computing efficiency of detecting fraudulent transactions over existing network-transaction-security systems. In some cases, such a fraud detection machine-learning model can find feature patterns that existing network-transaction-security systems cannot detect.

### BRIEF DESCRIPTION OF THE DRAWINGS

The detailed description provides one or more embodiments with additional specificity and detail through the use of the accompanying drawings, as briefly described below.

FIG. 1 illustrates a computing system environment for implementing a fraud detection system in accordance with one or more embodiments.

FIG. 2 illustrates a fraud detection system utilizing a fraud detection machine-learning model to generate a fraud prediction for a network transaction in accordance with one or more embodiments.

FIG. 3 illustrates a fraud detection system generating a fraud prediction and performing one or more corresponding digital actions in accordance with one or more embodiments.

FIG. 4 illustrates a fraud detection system transmitting a verification request to verify a network transaction in accordance with one or more embodiments.

FIG. 5 illustrates a fraud detection system training a fraud detection machine-learning model in accordance with one or more embodiments.

FIG. 6 illustrates a sample representation of features and corresponding feature importance values for generating a fraud prediction in accordance with one or more embodiments.

FIGS. 7A-7C illustrate graphs depicting an accuracy of a fraud detection system generating fraud predictions using a fraud detection machine-learning model in accordance with one or more embodiments.

FIG. 8 illustrates a graph depicting an importance of various features for in accordance with one or more embodiments.

FIGS. 9A-9C illustrate examples of different fraud prediction scores in accordance with one or more embodiments.

FIG. 10 illustrates a flowchart of a series of acts for utilizing a fraud detection machine-learning model to generate a fraud prediction for a network transaction in accordance with one or more embodiments.

FIG. 11 illustrates a block diagram of an example computing device for implementing one or more embodiments of the present disclosure.

FIG. 12 illustrates an example environment for an inter-network facilitation system in accordance with one or more embodiments.

### DETAILED DESCRIPTION

This disclosure describes one or more embodiments of a fraud detection system that in real time (or near real time) predicts whether an initiated network transaction is fraudulent based on a machine-learning model that intelligently weights features associated with the network transaction. For example, in less than a hundred millisecond latency, the fraud detection system can determine a network transaction is fraudulent based on device metadata, historical transactions, and other feature families. For instance, in one or more embodiments, the fraud detection system uses various IP distances between devices (e.g., at certain times) associated with a sender account and/or a recipient account to determine whether a given network transaction is fraudulent. Moreover, by utilizing a machine-learning model to analyze these and other features, the fraud detection system can intelligently adapt to new fraud schemes, changes to fraud algorithms, etc.

For example, in some embodiments, the disclosed fraud detection system can receive a request to initiate a P2P network transaction or other network transaction between network accounts, such as a sender account and a recipient account. In response to the request, the disclosed systems identify one or more features associated with the network transaction. Based the one or more features, the fraud detection system uses a fraud prediction machine-learning model to generate a fraud prediction for the network transaction. When the fraud prediction indicates the initiated network transaction is fraudulent or likely fraudulent, the fraud detection system suspends the network transaction. When the fraud prediction indicates the initiated network transaction is not fraudulent or unlikely fraudulent, the fraud detection system approves or processes the network transaction or releases the network transaction for further processing.

As just mentioned, in some embodiments, the fraud detection system identifies one or more features associated with the network transaction. In particular embodiments, these features relate to first device information, transaction details of the network transaction, device information prior to the network transaction being initiated, member service contact features, payment schedule features, recipient transaction history, sender transaction history, historical sender-recipient interactions, personal identifier reset features, and/or referral features.

Based on the one or more features, the fraud detection system uses a fraud detection machine-learning model to generate a binary fraud prediction, a fraud prediction score, or other fraud prediction. In some embodiments, the fraud detection machine-learning model generates a fraud prediction indicating the network transaction is (or is likely to be) fraudulent. In particular embodiments, the fraud detection machine-learning model generates a fraud prediction indicating a probability that the network transaction corresponds to a certain class of fraud (e.g., suspicious activity, account take over, or first-party fraud).

Based on the fraud prediction, the fraud detection system can suspend the network transaction. For example, before processing the network transaction, the fraud detection system can prevent completion of the network transaction such that funds are not exchanged between network accounts. By contrast, the fraud detection system can approve the network transaction based on the fraud prediction indicating no fraud (or a fraud score that fails to satisfy a threshold fraud score).

If the fraud detection system suspends a network transaction, the fraud detection system subsequently denies or approves the network transaction (e.g., upon verifying one or both network accounts corresponding to the network transaction). For instance, the fraud detection system can deny the transaction based on verification of the fraud prediction. In addition, the fraud detection system can also deactivate or suspend a network account. Additionally or alternatively, the fraud detection system can suspend an associated network transaction (e.g., an Apple® Pay transaction) to help prevent a fraudulent work-around. By contrast, the fraud detection system can approve the network transaction and unsuspend network accounts based on verifying the fraud prediction was a false positive.

To verify a network account, in some cases, the fraud detection system can implement one or more verification processes based on a fraud prediction. In some embodiments, the fraud detection system transmits a verification request to one or more client devices associated with a network account. For example, the verification request can include a live-image capture request (e.g., a selfie image), an identification-document (ID) scan, a biometric scan, etc. In one or more embodiments, the type of verification request corresponds to the fraud prediction (e.g., a fraud prediction score). For instance, the fraud detection system may transmit a more robust verification request (e.g., selfie+scan ID) for higher fraud prediction scores indicating a higher probability of fraud. In contrast, the fraud detection system may transmit easier, more convenient or less stringent forms of verification (e.g., a verification query-response) for lower fraud prediction scores indicating a lower probability of fraud.

In some embodiments, the fraud detection system trains the fraud detection machine-learning model utilizing one or more different approaches. In particular embodiments, the fraud detection system trains the fraud detection machine-learning model (e.g., a random forest machine-learning model) by comparing training fraud predictions and ground truth fraud identifiers. Additionally, in one or more embodiments, the fraud detection system determines a collective target value for fraud-claim reimbursements that compensate for valid fraud claims. Based on the collective target value, the fraud detection system can determine a precision metric threshold and/or a recall metric threshold for the fraud detection machine-learning model. In this manner, the fraud detection system can dynamically adjust one or more learned parameters that will comport with the collective target value for fraud-claim reimbursements.

As mentioned above, the fraud detection system can provide a number of technical advantages over conventional network-transaction-security systems. For example, the fraud detection system can improve fraud prediction accuracy and, therefore, improve network security. To illustrate, the fraud detection system uses a fraud detection machine-learning model that generates more accurate fraud predictions for network transactions than existing network-transaction-security systems, such as rigid heuristic-based-computational models. By using a unique combination of features associated with a network transaction, the fraud detection system trains (or uses a trained version of) a fraud detection machine-learning model to generate finely tuned predictions of whether such initiated network transactions constitute fraud. In some cases, the fraud detection system identifies (and uses) a particular set of transaction features that—when combined and weighted according to learned parameters—constitute a digital marker or fraud fingerprint to accurately predict whether a network transaction is fraudulent or legitimate. Indeed, as depicted and described below, the fraud detection machine-learning model is trained to intelligently weight features to more accurately generate fraud predictions for network transactions.

In addition to improved accuracy and network security, the fraud detection system can also improve system speed and efficiency of determining an authenticity or legitimacy of an initiated network transaction. For example, the fraud detection system can intelligently differentiate between authentic and fraudulent network transactions by utilizing a fraud detection machine-learning model trained on a particular combination of weighted features for network transactions. Uniquely trained with such combinations and learned feature weightings, the fraud detection machine-learning model can detect fraudulent action in real time (or near-real time) without processing multiple transactions of a serial fraudster or other target account. That is, the fraud detection system need not identify multiple instances of suspicious digital activity before predicting a network transaction is likely fraudulent. Rather, the fraud detection system can identify first instances of fraud based on particular combinations of transaction data, sender account historical data, sender device data, recipient account historical data, recipient device data, customer-service-contact data, payment schedule data, new-account-referral data, and/or historical-sender-recipient-account interactions. In addition, the fraud detection system can, within milliseconds, check for fraud and either approve or suspend the network transaction. Then, without undue back-and-forth communications, the fraud detection system can quickly authenticate a network account and either approve the network transaction or deny the network transaction.

Beyond improved accuracy and speed, in some cases, the fraud detection system can improve security of network transactions by flexibly tailoring verification actions based on the fraud prediction. For example, the fraud detection system may combat more sophisticated fraud (or more probable instances of fraud) by transmitting particular types of verification requests. To illustrate, the fraud detection system may escalate the type or security of verification requests (e.g., multiple forms of verification)—with such requests becoming more difficult for unauthorized persons to obtain or provide-based on a corresponding threshold for the fraud prediction. Examples of these more intensive forms of verification include live-image capture requests, ID scans, and biometric scans. In a similar manner, the fraud detection system can de-escalate verification requests for less sophisticated or less probable fraudulent transactions. Unlike rigid approaches of conventional systems, this escalate and de-escalate authentication approach is flexible and adaptable on an individual transaction basis that improves network security for a variety of different fraudulent network transactions.

As illustrated by the foregoing discussion, the present disclosure utilizes a variety of terms to describe features and benefits of fraud detection system. Additional detail is now provided regarding the meaning of these terms. For example, as used herein, the term “network transaction” refers to a transaction performed as part of an exchange of tokens, currency, or data between accounts or other connections of a computing system. In some embodiments, the network transaction can be a peer-to-peer (P2P) transaction that transfers currency, non-fungible tokens, digital credentials, or other digital content between network accounts. In some embodiments, the network transaction may be a transaction with a merchant (e.g., a purchase transaction).

In addition, the term “network account” refers to a computer environment or location with personalized digital access to a web application, a native application installed on a client device (e.g., a mobile application, a desktop application, a plug-in application, etc.), or a cloud-based application. In particular embodiments, a network account includes a financial payment account through which a user can initiate a network transaction on a client device or with which another user can exchange tokens, currency, or data. Examples of a network account include a CHIME® account, an APPLE® Pay account, a CHASE® bank account, etc. In addition, network accounts can be delineated by sender account and recipient account on a per-transaction basis. Relatedly, a “sender account” refers to a network account that initiates an exchange or transfer of (or is designated to send) tokens, currency, or data in a network transaction. In addition, a “recipient account” refers to a network account designated to receive tokens, currency, or data in a network transaction.

As also used herein, the term “feature” refers to characteristics or attributes related to a network transaction. In particular embodiments, a feature includes device-based characteristics associated with a client device corresponding to a sender account or recipient account involved in a network transaction. Additionally or alternatively, a feature includes account-based characteristics associated with a sender account or recipient account corresponding to a network transaction. Still further, a feature can include transaction-based details of one or more network transactions. This disclosure describes additional examples of features below.

As used herein, the term “fraud detection machine-learning model” refers to a machine-learning model trained or used to identify fraudulent network transactions. In some cases, a fraud detection machine-learning model refers to a trained machine-learning model that generates a fraud prediction for one or more network transactions. For example, a fraud detection machine-learning can utilize a random forest model, a series of gradient boosted decision trees (e.g., XGBoost algorithm), a multilayer perceptron, a linear regression, a support vector machine, a deep tabular learning architecture, a deep learning transformer (e.g., self-attention-based-tabular transformer), or a logistic regression. In other embodiments, a fraud detection machine-learning model includes a neural network, such as a convolutional neural network, a recurrent neural network (e.g., an LSTM), a graph neural network, a self-attention transformer neural network, or a generative adversarial neural network.

Additionally, as used herein, the term “fraud prediction” refers to a classification or metric indicating whether a network transaction is fraudulent. In some embodiments, a fraud prediction comprises a binary value indicating a network transaction is fraudulent, such as a “0” or a “1” or a “yes” or “no,” indicating the network transaction is or is not fraudulent. In other embodiments, a fraud prediction can comprise a fraud prediction score (e.g., a number, probability value, or other numerical indicator) indicating a degree or likelihood that a fraud detection machine-learning model predicts a network transaction is fraudulent. In certain implementations, a fraud prediction indicates a classification, score, and/or probability for various types or classes of fraud, such as account take over, first-party fraud, or suspicious activity.

Further, as used herein, the term “verification request” refers to a digital communication requesting verification of one or more credentials or information for one or more network accounts corresponding to a network transaction. In particular embodiments, a verification request includes a request for a verification response (e.g., a user input or message responsive to a verification request) to verify security or private information associated with a network transaction. For instance, if a verification response to a verification request verifies the authenticity of a network transaction, the fraud detection system can approve a currently suspended network transaction. In one or more embodiments, a verification request includes a live-image-capture request, an ID scan request, a biometric scan request, etc.

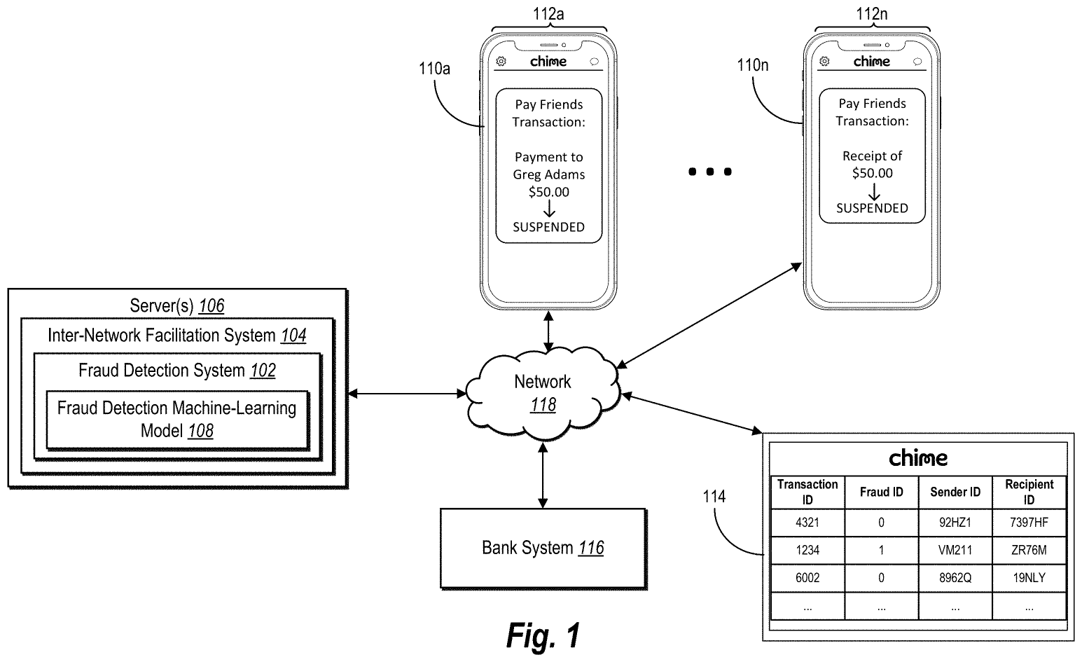

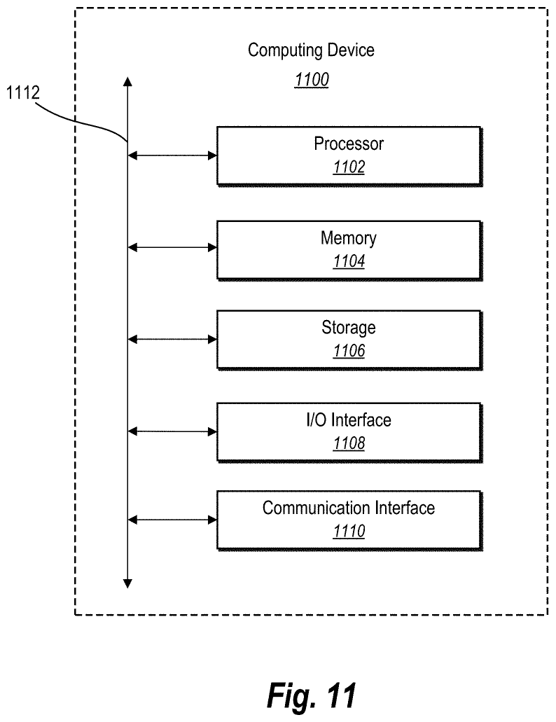

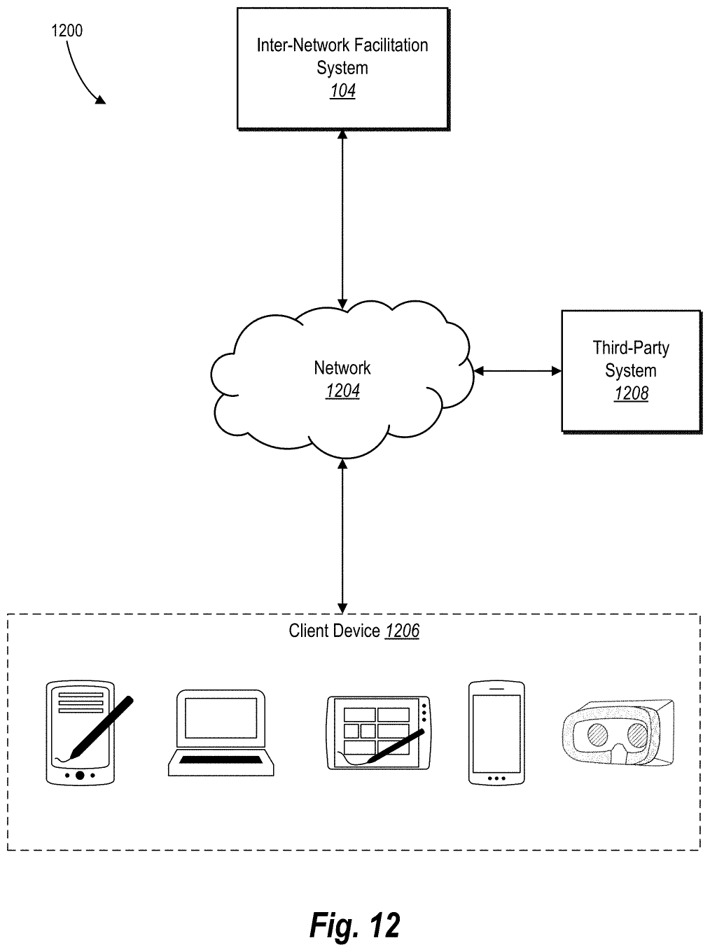

Additional detail regarding the fraud detection system will now be provided with reference to the figures. In particular, FIG. 1 illustrates a computing system environment for implementing a fraud detection system 102 in accordance with one or more embodiments. As shown in FIG. 1, the environment includes server(s) 106, client device(s) 110a-110n, an administrator device 114, and a bank system 116. Each of the components of the environment 100 communicate (or are at least configured to communicate) via the network 118, and the network 118 may be any suitable network over which computing devices can communicate. Example networks are discussed in more detail below in relation to FIGS. 11-12.

As further illustrated in FIG. 1, the environment 100 includes the server(s) 106. In some embodiments, the server(s) 106 comprises a content server and/or a data collection server. Additionally or alternatively, the server(s) 106 comprise an application server, a communication server, a web-hosting server, a social networking server, a digital content management server, or a financial payment server.

Moreover, as shown in FIG. 1, the server(s) 106 implement an inter-network facilitation system 104. In one or more embodiments, the inter-network facilitation system 104 (or the fraud detection system 102) communicates with the client device(s) 110a-110(n) to identify accounts associated with a network transaction. More specifically, the inter-network facilitation system 104 (or the fraud detection system 102) can communicate with one or more of the client devices 110a-110n to indicate a suspended network transaction, request verification, etc.

As additionally shown in FIG. 1, the fraud detection system 102 implements a fraud detection machine-learning model 108. The fraud detection machine-learning model 108 generates fraud predictions corresponding to network transactions. Specifically, the fraud detection machine-learning model 108 generates a fraud prediction for a network transaction based on one or more features corresponding to the network transaction. Based on the fraud prediction, the fraud detection system 102 can suspend the network transaction.

Further, the environment 100 includes the client devices 110a-110n. The client devices 110a-110n can include one of a variety of computing devices, including a smartphone, tablet, smart television, desktop computer, laptop computer, virtual reality device, augmented reality device, or other computing device as described in relation to FIGS. 11-12. Although FIG. 1 illustrates only two client devices, the environment 100 can include many different client devices connected to each other via the network 118 (e.g., as denoted by the separating ellipses). Further, in some embodiments, the client devices 110a-110n receive user input and provide information pertaining to accessing, viewing, modifying, generating, and/or initiating a network transaction to the server(s) 106.

Moreover, as shown, the client devices 110a-110n include corresponding client applications 112a-112n. The client applications 112a-112n can each include a web application, a native application installed on the client devices 110a-110n (e.g., a mobile application, a desktop application, a plug-in application, etc.), or a cloud-based application where part of the functionality is performed by the server(s) 106. In some embodiments, the fraud detection system 102 causes the client applications 112a-112n to present or display information to a user associated with the client devices 110a-110n, including information relating to fraudulent network transactions as provided in this disclosure.

The fraud detection system 102 can also communicate with the administrator device 114 to provide information relating to a fraud prediction. In some embodiments, the fraud detection system 102 causes the administrator device 114 to display, on a per-transaction basis, whether a network transaction between a sender account and a recipient account is fraudulent. Additionally or alternatively, the fraud detection system 102 can graphically flag certain fraudulent network transactions (e.g., a visual indicator for a certain class of fraud or a certain fraudulent prediction) for display on the administrator device 114.

In addition, the fraud detection system 102 can communicate with the bank system 116 regarding one or more network transactions. For example, the fraud detection system 102 can communicate with the bank system 116 to identify one or more of transaction data, network account data, device data corresponding to the client devices 110a-110n, etc.

In some embodiments, though not illustrated in FIG. 1, the environment 100 has a different arrangement of components and/or has a different number or set of components altogether. For example, in certain embodiments, the client devices 110a-110n communicate directly with the server(s) 106, bypassing the network 118. As another example, in one or more embodiments, the environment 100 optionally includes a third-party server (e.g., that corresponds to a different bank system). In particular embodiments, the fraud detection system 102 suspends network transactions associated with a third-party server (e.g., an Apple® Pay server) to help prevent a fraudulent work-around.

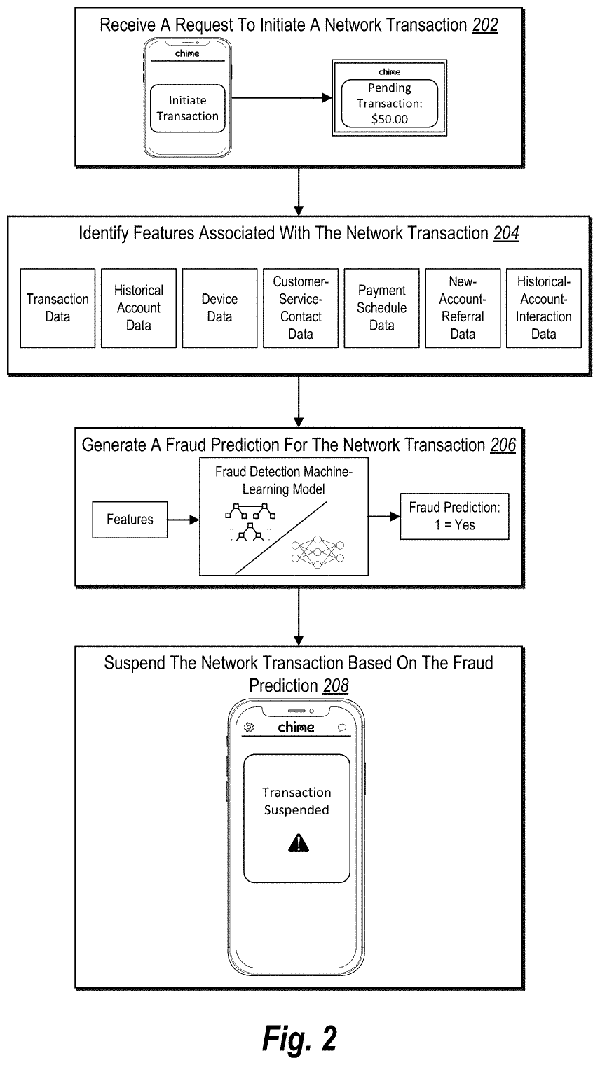

As mentioned above, the fraud detection system 102 can efficiently and accurately generate a fraud prediction. In accordance with one or more embodiments, FIG. 2 illustrates the fraud detection system 102 utilizing a fraud detection machine-learning model to generate a fraud prediction for an initiated network transaction based on features associated with the network transaction.

At an act 202 in FIG. 2, for example, the fraud detection system 102 receives a request to initiate a network transaction. In particular embodiments, the act 202 comprises identifying, from a sender account, a transaction request for transferring tokens, currency, or data to a recipient account. For instance, the act 202 comprises identifying, in real time (or near real time), an indication of a user input via a client application confirming a request to initiate a network transaction.

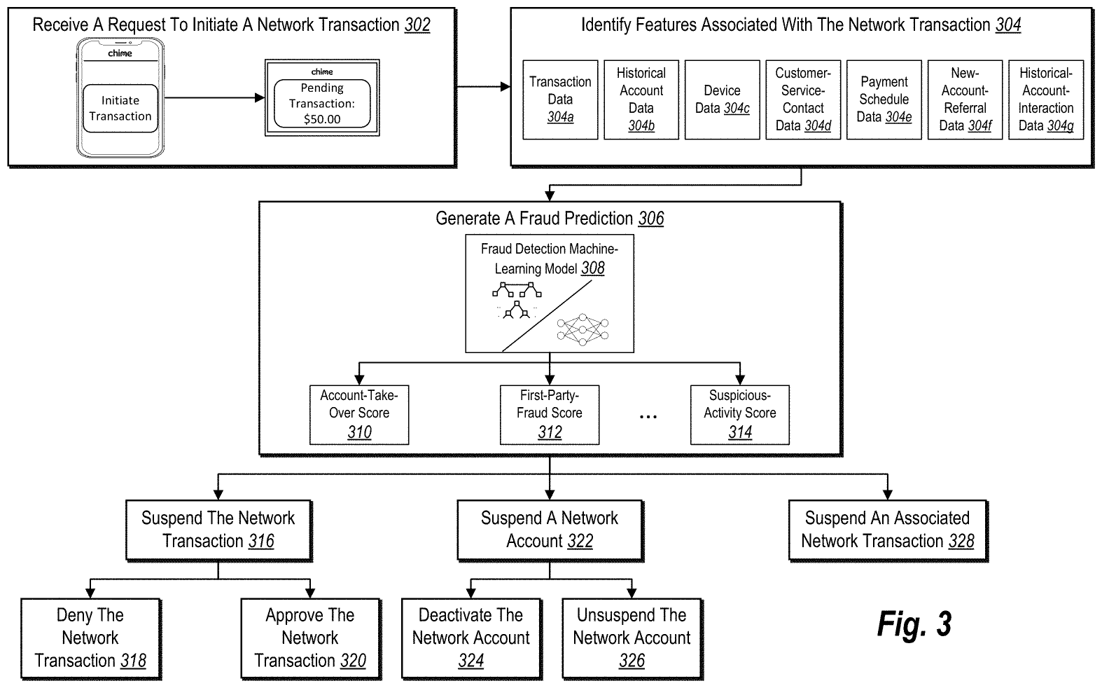

At an act 204, the fraud detection system 102 identifies features associated with the network transaction. In particular embodiments, the fraud detection system 102 responds to the request for initiating the network transaction by extracting or identifying previously determined device-based features, account-based features, and transaction-based features. To illustrate, the fraud detection system 102 identifies at least one of transaction data, sender account historical data, sender device data, recipient account historical data, recipient device data, customer-service-contact data, payment schedule data, new-account-referral data, or historical-sender-recipient-account interactions. These features are described in more detail below in relation to FIG. 3.

At an act 206 shown in FIG. 2, the fraud detection system 102 utilizes a fraud detection machine-learning model to generate a fraud prediction for the network transaction. In particular, from the identified features associated with the network transaction, the fraud detection system 102 uses the fraud detection machine-learning model to generate a fraud prediction. As shown at the act 206, the fraud prediction provides a binary value (“1=Yes”) to indicate that the network transaction is likely fraudulent. In other embodiments, however, the fraud detection machine-learning model generates a fraud prediction score (e.g., a non-binary value) that more precisely indicates how likely the network transaction is fraudulent. Further, in some embodiments, the fraud detection machine-learning model generates a fraud prediction indicating a classification, score, and/or probability for various types or classes of fraud (e.g., account take over, suspicious activity, or first-party fraud).

At an act 208, the fraud detection system 102 suspends the network transaction based on the fraud prediction. For example, based on the fraud prediction being “1=Yes,” the fraud detection system 102 suspends the network transaction by disallowing transfer of the requested tokens, currency, or data for the network transaction. In contrast, if the fraud prediction is “0=No,” the fraud detection system 102 approves the network transaction and allows the network transaction to proceed to completion.

As mentioned above, the fraud detection system 102 utilizes a fraud detection machine-learning model to generate a fraud prediction. Based on the fraud prediction, the fraud detection system 102 can perform various responsive actions. For example, the fraud detection system 102 can suspend a network transaction, a network account, and/or an associated network transaction. In accordance with one or more such embodiments, FIG. 3 illustrates the fraud detection system 102 generating a fraud prediction and performing one or more corresponding digital actions.

At an act 302, for example, the fraud detection system 102 receives a request to initiate a network transaction. The act 302 is the same as or similar to the act 202 described above in relation to FIG. 2. For example, the fraud detection system 102 identifies one or more user interactions within a client application logged into a network account to submit a network transaction. For example, the fraud detection system 102 may identify swipe interactions, button presses, taps, etc. in relation to one or more user interface elements configured to initiate a network transaction.

At an act 304, the fraud detection system 102 identifies features associated with the network transaction. Indeed, as shown, the fraud detection system 102 identifies at least one of transaction data 304a, historical account data 304b, device data 304c, customer-service-contact data 304d, payment schedule data 304e, new-account-referral data 304f, or historical-account-interaction data 304g. The following paragraphs briefly describe and give examples of such features.

In one or more embodiments, the transaction data 304a includes elements associated with the requested network transaction. For example, the transaction data 304a may include date, time, transfer amount, etc.

In addition, the historical account data 304b may include historical information for sender and recipient accounts of a predetermined period of time preceding the requested network transaction (e.g., minutes, hours, days, weeks, months, and years prior). Examples of the historical account data 304b include average balance, an average amount of P2P transactions, an account maturity (or account age since enrollment), etc.

Further, the device data 304c may include device-specific information for a sender device and recipient device. In particular embodiments, the device data 304c includes an IP address at predetermined times (e.g., at the time of requested transaction, one day prior, one week prior, one month prior). In some embodiments, the device data 304c includes position data, such as global positioning system data, address, city/state information, zip code, time-zone, etc. Additionally or alternatively, the device data 304c includes an operating system identifier, device manufacturer, device identifier (e.g., serial number), device carrier information, or a type of device (e.g., mobile device, tablet, desktop computer).

The customer-service-contact data 304d includes various details regarding interactions between a network account and customer service of a bank system. In one or more embodiments, the customer-service-contact data 304d includes fraud claims, help requests, complaints, etc. In certain implementations, the customer-service-contact data 304d includes frequency of contact, form of contact (e.g., chat versus phone call), customer rating, date and time of recent customer service contact, etc.

The payment schedule data 304e includes payday information, such as a day of the week scheduled for direct deposits. In addition, for example, the payment schedule data 304e includes bill payments scheduled to issue and/or a number of prior-completed direct deposits.

The new-account-referral data 304f includes information about referring another user to enroll or open a new network account. In some embodiments, the new-account-referral data 304f includes an amount of attempted referrals, an amount of referrals over a period of time, whether enrollment occurred through a referral, etc.

The historical-account-interaction data 304g includes information relating to previous interactions between a sender account and a recipient account corresponding to a network transaction. For example, the historical-account-interaction data 304g includes a number of previous interactions, a frequency of interactions, an average transaction amount exchanged between the sender account and the recipient account, etc.

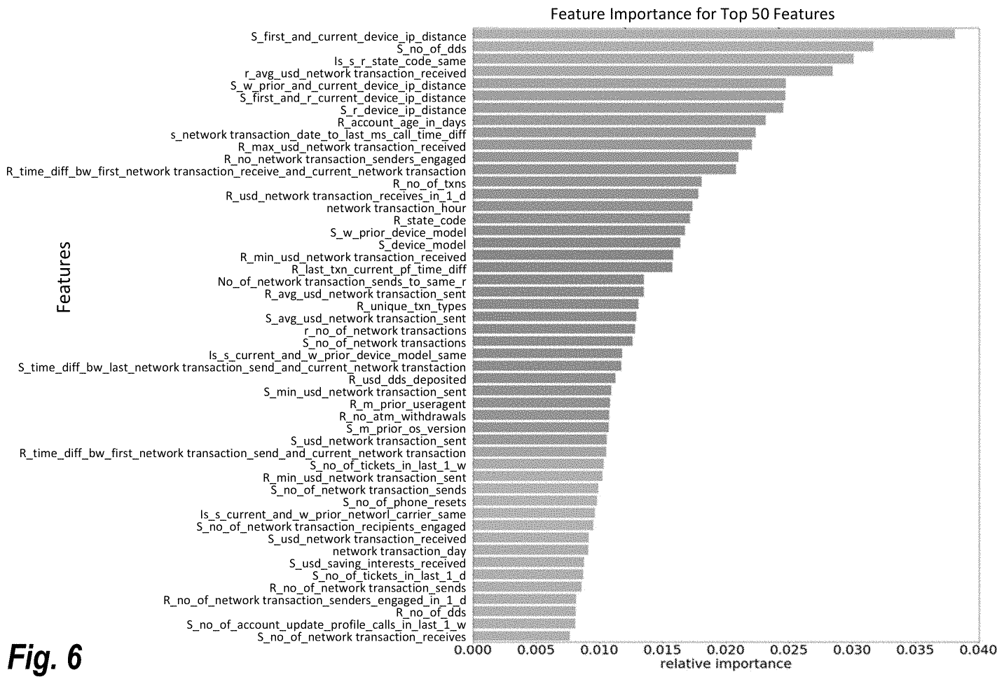

As further shown in FIG. 3, at an act 306, the fraud detection system 102 generates a fraud prediction utilizing a fraud detection machine-learning model 308. In particular embodiments, the fraud detection machine-learning model 308 analyzes one or more of the features identified at the act 304 described above. Additionally or alternatively, the fraud detection machine-learning model 308 analyzes one or more of the features indicated in FIG. 6 and Table 2 described below.

In one or more embodiments, the fraud detection machine-learning model 308 utilizes one or more different approaches to analyzing features associated with the requested network transaction. In certain implementations, however, the fraud detection machine-learning model 308 analyzes the features associated with a network transaction according to a feature importance scheme or feature weighting (e.g., as shown in FIG. 6). Additionally or alternatively, the fraud detection machine-learning model 308 uses various parameters. For instance, in one or more embodiments, the fraud detection machine-learning model 308 comprises a random forest ensemble tree model. In this model version, the fraud detection machine-learning model 308 comprises various hyper parameters, such as n_estimators=300, max_features=‘auto’, max_depth=None, min_samples_leaf=1, min_weight_fraction leaf=0.0, min_samples_split=2, bootstrap=True, n_jobs=−1, ccp_alpha=0.0, class_weight=None, criterion=‘gini’, max_leaf_nodes=None, max_samples=None, min_impurity_decrease=0.0, min_impurity_split=None, oob_score=False, random_state=None, verbose=0, warm_start=False.

Based on analyzing the features associated with the network transaction, the fraud detection machine-learning model 308 generates a fraud prediction. As described above in relation to FIG. 2, the fraud prediction can include a binary value (e.g., “1=Yes”) to indicate that the network transaction is likely fraudulent. In other embodiments, however, the fraud detection machine-learning model 308 generates a fraud prediction score (e.g., a non-binary value) that more precisely indicates how likely the network transaction is fraudulent. In particular embodiments, the fraud detection machine-learning model 308 generates a fraud prediction score composed of one or more fraud prediction scores for a particular class of fraud. Indeed, as shown at the act 306 of FIG. 3, the fraud detection machine-learning model 308 generates an account-take-over score 310, a first-party-fraud score 312, and/or a suspicious-activity score 314 (among other potential scores).

To illustrate on particular embodiment, when using a random forest model, the fraud detection machine-learning model 308 can generate the fraud prediction—including the account-take-over score 310, the first-party-fraud score 312, and/or the suspicious-activity score 314—by weighting the features according to a plurality of decision trees. Each decision tree in the plurality of decision trees can determine a corresponding fraud prediction (e.g., one or more fraud prediction scores). Subsequently, the fraud detection machine-learning model 308 can combine (e.g., average) the plurality of fraud predictions from each decision tree of the plurality of decision trees to generate a global fraud prediction. This global fraud prediction can include, for example, an average of, a weighted average of, or a highest or lowest score from the account-take-over score 310, the first-party-fraud score 312, and/or the suspicious-activity score 314.

In one or more embodiments, the account-take-over score 310 indicates a probability that a network transaction corresponds to an account take over (or ATO event). An ATO event can occur when a network account is infiltrated or taken control of by an outside computing device. Specifically, an ATO event can occur by means of social engineering, compromised network credentials, or various types of remote login (often done surreptitiously). Accordingly, the account-take-over score 310 indicates a probability that the network transaction is unauthorized and a result of an ATO event.

In addition, in some cases, the first-party-fraud score 312 indicates a probability that a network transaction corresponds to first-party fraud. First-party fraud can similarly take on many different forms. However, unlike most ATO events, first-party fraud involves overt acts to deceive and defraud a network account (or customer service). For example, first-party fraud can include dispute fraud, bitcoin scams, ticket scams, cash flip scams, and collusion or fake account take over. Therefore, the first-party-fraud score 312 indicates a probability that the network transaction constitutes a fraudulent self-orchestration by at least one of a sender account or (more commonly) a recipient account.

Further, in certain embodiments, the suspicious-activity score 314 indicates a probability that a network transaction corresponds to suspicious activity. Examples of suspicious activity includes unemployment insurance offloading, gambling, money laundering, or illicit offloading of loan funds (e.g., small business administration disaster (SBAD) loans, economic injury disaster loans (EIDL)). As a result, the suspicious-activity score 314 indicates a probability that the network transaction establishes suspicious activity occurring between a sender account and a recipient account—often both network accounts for suspicious activity.

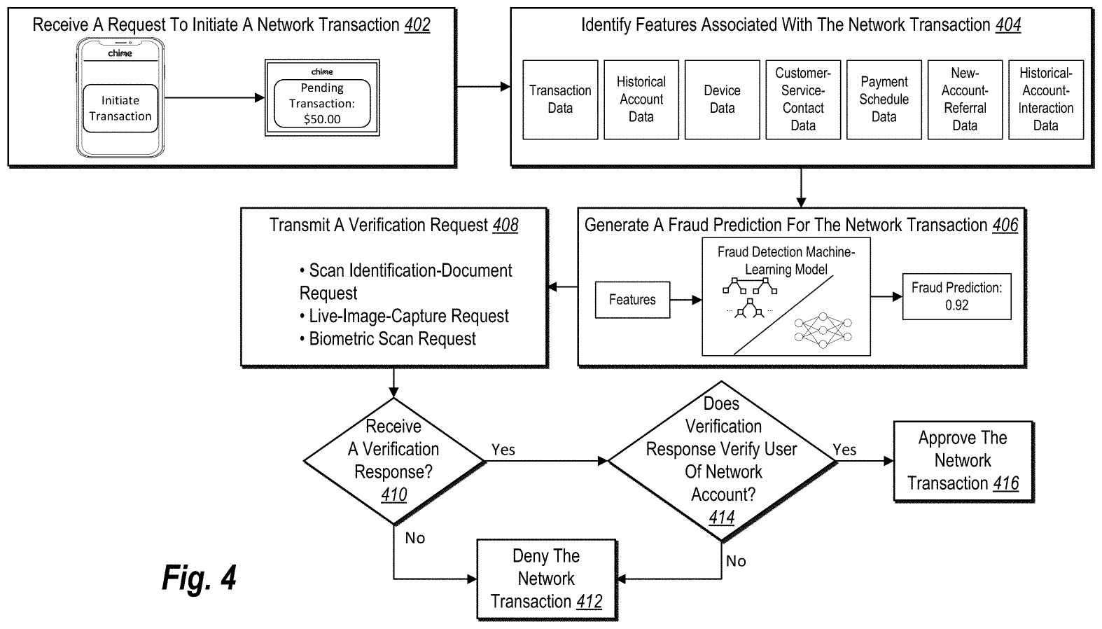

Based on the fraud prediction, the fraud detection system 102 performs various acts. For example, at an act 316, the fraud detection system 102 suspends the network transaction. The act 316 may include temporarily stopping the transfer of funds between network accounts. For instance, the fraud detection system 102 may suspend the network transaction until verification processes can be performed (e.g., as described below in relation to FIG. 4).

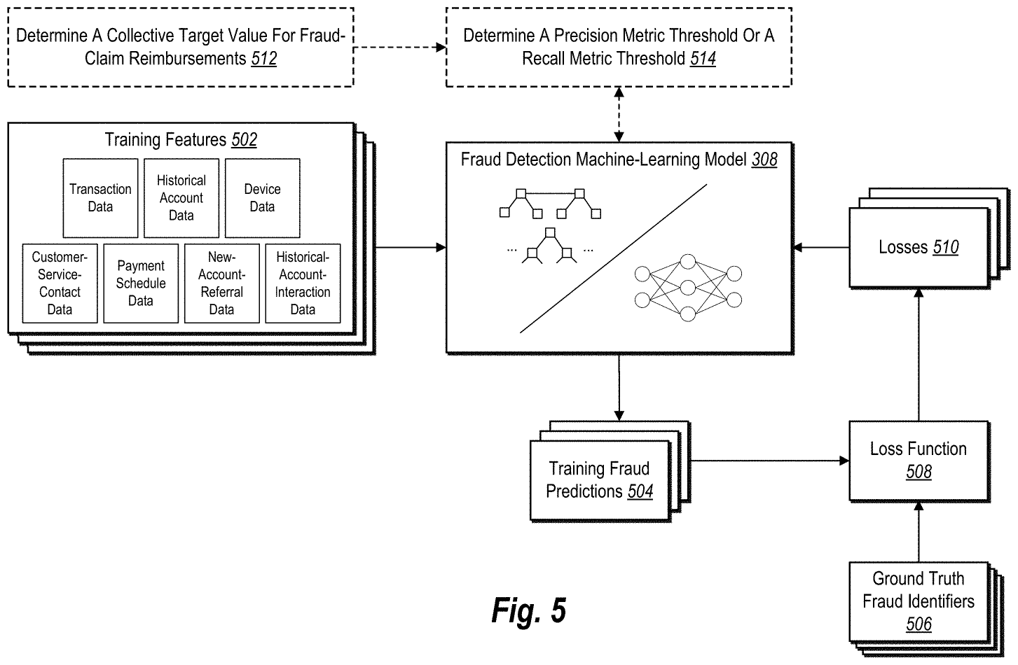

After suspending the network transaction, the fraud detection system 102 either denies the network transaction at an act 318 or approves the network transaction at an act 320. At the act 318, the fraud detection system 102 changes the temporary suspension of the network transaction to a rejection. For example, the fraud detection system 102 labels the network transaction as fraudulent and rejects the network transaction from issuing or completing. In one or more embodiments, the fraud detection system 102 saves the fraudulent transaction and corresponding data for training purposes (e.g., as described below in relation to FIG. 5).

At the act 320, the fraud detection system 102 approves the network transaction. For example, in response to successful verification processes, the fraud detection system 102 unsuspends the network transaction. In one or more embodiments, unsuspending the network transaction allows the network transaction to issue or complete (e.g., such that funds between network accounts settle). Additionally, in one or more embodiments, the fraud detection system 102 whitelists the network account and/or similar transactions associated with a network account (e.g., to reduce or prevent future false positives). For example, the fraud detection system 102 whitelists the network account and/or similar transactions for a grace period (e.g., about one month).

In addition or in the alternative to suspending the network transaction, the fraud detection system 102 can suspend a network account. For example, at an act 322, the fraud detection system 102 suspends at least one of a sender account or a recipient account corresponding to the network transaction. To illustrate, the fraud detection system 102 locks out or freezes a network account—thereby preventing further use or access to the network account. In one or more embodiments, this approach can prevent further unauthorized attempts to initiate additional fraudulent network transactions.

After suspending a network account, the fraud detection system 102 can likewise deactivate the network account or unsuspend the network account (depending on the verification processes). For example, at an act 324, the fraud detection system 102 deactivates the network account by unenrolling the network account and prohibiting further access to a bank system. In certain implementations, the fraud detection system 102 initiates further steps, such as banning an associated user, garnishing account funds, and/or reporting illicit activity to the proper legal authorities.

In addition or in the alternative to suspension, at the act 326, the fraud detection system 102 can unsuspend the network account. For example, the fraud detection system 102 reinstates full access and/or use of the network account after confirming security information or receiving a satisfactory response to a verification request, as explained below. Additionally, in some embodiments, the fraud detection system 102 can update a fraud prediction for an initiated network transaction based on one or more updated features and unsuspend the network account based in part on the one or more updated features.

As further shown in FIG. 3, in some embodiments, the fraud detection system 102 performs an act 328 to suspend an associated network transaction. For example, the fraud detection system 102 transmits a digital communication to a third-party server (e.g., for a third-party bank system) to initiate a suspension request of an associated network transaction. In such cases, the network account may be part of, connected to, or implemented by a digital wallet—such as an Apple® Pay account or a Google® Pay account. Accordingly, suspending an associated network transaction can prevent a fraudulent work-around that attempts to use a different network account associated with the digital wallet to perform another fraudulent network transaction (e.g., with a same or different network account).

As mentioned above, the fraud detection system 102 can flexibly verify a network transaction. In accordance with one or more such embodiments, FIG. 4 illustrates the fraud detection system 102 transmitting a verification request to verify a network transaction. As shown, FIG. 4 includes an act 402 of receiving a request to initiate a network transaction, an act 404 of identifying features associated with the network transaction, and an act 406 of generating a fraud prediction for the network transaction. The acts 402-406 are the same as or similar to the acts 202-206 and the acts 302-306 described above in relation to FIGS. 2-3 and include the embodiments described above.

As shown in FIG. 4, at an act 408, the fraud detection system 102 transmits a verification request. In one or more embodiments, the verification request comprises one or more of an ID scan request, a live-image-capture request, or a biometric scan request. The following paragraphs describe examples of such verification requests.

A scan ID request comprises a request to provide (e.g., scan and upload) a personal identification document, such as a driver's license, passport, birth certificate, utility bill, etc. In particular embodiments, the scan ID request indicates acceptance of certain types of picture files (e.g., .JPG) generated by a client device. Additionally or alternatively, the scan ID request is interactive such that, upon user interaction, the fraud detection system 102 causes the client device to open a viewfinder of a scan application or a camera application.

In addition, a live-image-capture request comprises a request for an image of at least a face of a user associated with a network account. In one or more embodiments, the live-image-capture request comprises a request for a selfie image taken impromptu or on the spot. Accordingly, in certain implementations, the live-image-capture request opens a camera viewfinder of a client device so that a user of the client device may position the user's face inside the camera viewfinder (e.g., within a threshold period of time) before the live-image-capture request expires.

By contrast, a biometric scan request comprises a request for a fingerprint, retina scan, or other verified biomarker of a user associated with a network account. For example, receiving the biometric scan request may cause the client device of a network account to instantiate a fingerprint reader, a retina scanner, etc. for impromptu extraction of a corresponding biomarker of a user associated with the client device.

In one or more embodiments, the type of verification request depends on the fraud prediction. For example, in certain implementations, the fraud detection system 102 transmits a verification request that escalates or de-escalates the level of requested verification depending on the probability of fraud or class of fraud indicated by the fraud prediction. To illustrate, the fraud detection system 102 transmits a first type of verification request for a low probability range of fraud (e.g., fraud prediction scores of 0-0.01), a second type of verification request for a medium probability range of fraud (e.g., fraud prediction scores of 0.1-0.65), and a third type of verification request for a high probability range of fraud (e.g., fraud prediction scores of 0.65-1.0).

In one or more embodiments, the fraud detection system 102 escalates the type of verification request for higher probabilities of fraud by requesting multiple types of verification (e.g., scan ID+selfie) or multiple iterations of a same type of verification (e.g., a driver's license scan+a passport scan). In contrast, in some embodiments, the fraud detection system 102 de-escalates the type of verification request for lower probabilities of fraud by requesting fewer types of verification, more convenient types of verification (e.g., no scan ID request), etc.

As further shown in FIG. 4, at an act 410, the fraud detection system 102 determines whether a verification response was received. If no, at an act 412, the fraud detection system 102 denies the network transaction by changing a transaction status from temporary suspension to rejection—thereby preventing the network transaction from issuing or completing.

If the fraud detection system 102 receives a verification response, at an act 414, the fraud detection system 102 determines whether the verification response verifies a network account user. In particular, the fraud detection system 102 compares the verification response comprising an image, extracted biomarker, etc. to verified user identity information. For example, the fraud detection system 102 compares the verification response to verified facial features and geometric proportions using facial recognition software. As another example, the fraud detection system 102 compares the verification response to verified driver's license data, passport data, etc. that were previously provided or uploaded by a user corresponding to a network account.

If the fraud detection system 102 determines the verification response does not verify a user of the network account, the fraud detection system 102 denies the network transaction. Otherwise, the fraud detection system 102 approves the network transaction at an act 416. For example, the fraud detection system 102 unsuspends the network transaction—thereby allowing the network transaction to issue or complete (e.g., such that funds between network accounts settle).

As mentioned above, the fraud detection system 102 can train the fraud detection machine-learning model to intelligently generate fraud predictions for network transactions. FIG. 5 illustrates the fraud detection system 102 training the fraud detection machine-learning model 308 in accordance with one or more embodiments.

As shown in FIG. 5, the fraud detection system 102 determines a set of training features from training features 502 corresponding to a training network transaction. In a given training iteration, the training network transaction also corresponds to a ground truth fraud identifier from ground truth fraud identifiers 506. As indicated above, the training features 502 includes various features, such as transaction data, sender account historical data, sender device data, recipient account historical data, recipient device data, customer-service-contact data, payment schedule data, new-account-referral data, or historical-sender-recipient-account interactions. Additionally or alternatively, the fraud detection system 102 identifies a set of training features corresponding to a training network transaction (from the training features 502) by identifying features described below in relation to FIG. 6. In one or more embodiments, the fraud detection system 102 identifies the training features 502 by extracting features from historical network transactions.

In addition, the fraud detection machine-learning model 308 generates a training fraud prediction from training fraud predictions 504 by analyzing the set of training features from the training features 502 corresponding to a given training network transaction. As described above, the fraud detection machine-learning model 308 can analyze features in a variety of different ways. For example, the fraud detection machine-learning model 308 comprises a plurality of decision trees as part of a random forest model. Based on a given set of training features from the training features 502, the fraud detection machine-learning model 308 then combines a plurality of training fraud predictions from the plurality of decision trees to generate a particular training fraud prediction from the training fraud predictions 504.

After generating a particular training fraud prediction, the fraud detection system 102 evaluates the quality and accuracy of the particular training fraud prediction from the training fraud predictions 504 based on a corresponding ground truth from the ground truth fraud identifiers 506. In some embodiments, the fraud detection system 102 generates the ground truth fraud identifiers 506 in one or more different ways. In particular embodiments, the fraud detection system 102 generates the ground truth fraud identifiers 506 utilizing a labeling approach based on historical network transactions. An example labeling approach comprises (i) determining whether a fraud claim for a network transaction has been paid and (ii) determining a fraud label for the network transaction (if applicable). The fraud detection system 102 then labels a network transaction as fraudulent if the network transaction is associated with both an unpaid fraud claim and a fraud label. Otherwise, the fraud detection system 102 labels the network transaction as non-fraudulent. This logic is represented in the following pseudocode of Table 1:

```
CASE WHEN
dispute_reason= ′unauthorized_transfer′ AND
resolution_code IN (′Fraud-Closed Approved′,′Closed-Credit client′, ′Closed-Finalize prov
      credit′, ′Closed-Merchant issued credit′, ′Closed-Write Off, ′Fraud - Closed Under
      Threshold′, ′Closed-Reverse prov credit′)
THEN 1
ELSE 0
END AS is_claim_paid
CASE WHEN
transaction_label IN (′authorized_transfer_cash_flip_scam′,
′authorized_transfer_scam′,′unauthorized_transfer_ato_sender′,′unauthorized_transfer_ato′,
′authorized_transfer_bitcoin_scam′,′authorized_transfer_credential_sharing′,′authorized_
transfer_money_laundering′,′unauthorized_transfer_credential_sharing′,′suspicious_transfers_
authorized′,′authorized_suspicious_transfers′,′unauthorized_transfer_device_stolen′,
′authorized_transfer_unemployment_fraud′,′unauthorized_transfer_ato_receiver′,
′unauthorized_transfer_ato_bitcoin′,′authorized_suspicious_transfers_gambling′,
′unauthorized_transfer_received_in_error′,′unauthorized_transfer_ato_sender_
compromised_creds′,′authorized_transfer_faked_ato′,′authorized_transfer_not_scam′,
′authorized_transfer_unemployment′,′unauthorized_transfer_dormant_receiver′,′authorized_
transfer_first_party_fraud′)
THEN 1
ELSE 0
END AS is_bad_label
CASE WHEN
Is_bad_label=1 AND is_claim_paid = 0
THEN 1
ELSE is_claim_paid
END AS is_fraud
CASE WHEN
h_clean_transaction_to_same_recipients>0 AND is_claim_paid=1 AND is_bad_label !=1
THEN 0
ELSE is_fraud
END AS is_fraud
```

### Table 1

As further shown in FIG. 5, in a given training iteration, the fraud detection system 102 compares a given training fraud prediction from the training fraud predictions 504 and a corresponding ground truth fraud identifier from the ground truth fraud identifiers 506 utilizing a loss function 508. In one or more embodiments, the loss function 508 comprises a regression loss function (e.g., a mean square error function, a quadratic loss function, an L2 loss function, a mean absolute error/L1 loss function, mean bias error). Additionally or alternatively, the loss function 508 can include a classification-type loss function (e.g., a hinge loss/multi-class SVM loss function, cross entropy loss/negative log likelihood function). In particular embodiments, the loss function 508 comprises a k-fold (e.g., 5-fold) cross-validation function.

Further, the loss function 508 can return quantifiable data regarding the difference between a given training fraud prediction from the training fraud predictions 504 and a corresponding ground truth fraud identifier from the ground truth fraud identifiers 506. In particular, the loss function 508 can return losses 510 to the fraud detection machine-learning model 308 based upon which the fraud detection system 102 adjusts various parameters/hyperparameters to improve the quality/accuracy of training fraud predictions in subsequent training iterations—by narrowing the difference between training fraud predictions and ground truth fraud identifiers in subsequent training iterations.

Optionally, at an act 512, the fraud detection system 102 determines a collective target value for fraud-claim reimbursements. For example, the fraud detection system 102 determines the collective target value for fraud-claim reimbursements by determining a monetary value associated with reimbursing fraudulent network transactions approved or undetected by a fraud detection machine-learning model. To illustrate, the fraud detection system 102 determines the collective target value for fraud-claim reimbursements by determining a monetary ceiling or optimal value. In certain implementations, however, the fraud detection system 102 determines the collective target value for fraud-claim reimbursements based on a target distribution of fraudulent versus non-fraudulent network transactions.

In one or more embodiments, the fraud detection system can improve (e.g., decrease) a collective target value for fraud-claim reimbursements. For example, at an act 514, the fraud detection system 102 determines a precision metric threshold or a recall metric threshold indicating a level of fraud detection for a fraud detection machine-learning model.

As used herein, the term “precision metric threshold” refers to a predetermined ratio of true positive fraud predictions over a sum of the true positive fraud predictions and false positive fraud predictions. In addition, the term “recall metric threshold” refers to a predetermined ratio of the true positive fraud predictions over a sum of the true positive fraud predictions and false negative fraud predictions.

By determining such threshold metrics, the fraud detection system 102 can, in turn, dynamically adjust one or more learned parameters of the fraud detection machine-learning model 308 that will comport with the collective target value for fraud-claim reimbursements. That is, based on the one or more learned parameters, the fraud detection machine-learning model 308 can learn to generate fraud predictions in a manner that leads to the fraud detection system 102 providing an actual value of fraud-claim reimbursements that approximately equals the target value for fraud-claim reimbursements.

It will be appreciated that the act 514 and correspondingly adjusting one or more model parameters can be an iterative process. For example, over training iterations, the fraud detection system 102 may adjust at least one of a precision metric threshold or a recall metric threshold such that the fraud detection system 102 can narrow the difference between an actual value of fraud-claim reimbursements and the target value of fraud-claim reimbursements. To illustrate, over training iterations, the fraud detection system 102 may adjust at least one of the precision metric threshold or the recall metric threshold to more closely achieve a target distribution of fraudulent versus non-fraudulent network transactions.

As mentioned above, the fraud detection system 102 can intelligently generate a fraud prediction based on certain combinations and/or weightings of features associated with a network transaction. FIG. 6 illustrates a sample representation of features and corresponding feature importance values for generating a fraud prediction in accordance with one or more embodiments.

In particular, FIG. 6 shows a chart 600 indicating the feature importance for a set of features analyzed by the fraud detection machine-learning model 308. The chart 600 shows relative importance along an X-axis and features along a Y-axis. Specifically, each of the features in the chart 600 correspond to a relative importance value based on the Gini index. Additionally, each of the features correspond to at least one of a sender account, sender device, recipient account, or recipient device in a network transaction.

To illustrate, the first (top) feature comprises an internet protocol (IP) address distance between (i) a historical IP address of an initial sender device historically corresponding to a sender account and (ii) a current IP address of a current sender device corresponding to the sender account that requests initiation of the network transaction. The second feature comprises a number of historical deposits associated with the sender account. The third feature comprises a geographical region (e.g., indicated by state codes) associated with a sender account and the recipient account.

As further shown in FIG. 6, the fourth feature comprises an average transaction amount that a recipient account of receives from sender accounts via peer-to-peer network transactions. The fifth feature comprises an IP address distance between a recent IP address of a sender device used one week prior to requesting initiation of the network transaction and the current recipient IP address of the recipient device. The sixth feature comprises an IP address distance between a historical IP address of the initial sender device and a current recipient IP address of the recipient device. The seventh feature comprises an IP address distance between the current IP address of the current sender device and the current recipient IP address of the recipient device.

These and other features are further defined according to Table 2 below. Indeed, although FIG. 6 illustrates fifty features, the fraud detection system 102 can analyze more or fewer features—including additional or alternative features other than those illustrated and described in this disclosure. For example, Table 2 below defines 126 features that the fraud detection machine-learning model 308 can dynamically analyze within milliseconds to intelligently generate a fraud prediction for a network transaction. In particular, column 1 includes the “Feature” column providing a feature identifier of a given feature. In addition, column 2 includes the “Description” column providing a brief description or definition of the corresponding feature in column 1.

TABLE 2

| Feature | Description |
|---|---|
| s_first_and_current_ | Geographical IP distance b/w current |
| device_ip_distance | network transaction sender′s first |
| | seen IP and current sender′s IP |
| s_no_of_dds | No of historical direct deposits |
| | made by sender |
| s_w_prior_and_r_ | Geographical IP distance b/w current |
| current_device_ | network transaction sender′s 1 week |
| ip_distance | prior IP and current recipient′s IP |
| s_first_and_r_current_ | Geographical distance, lat-long, |
| device_ip_distance | between sender first seen IP and |
| | network transaction sender IP |
| s_r_device_ip_ | Geographical IP distance b/w current |
| distance | network transaction sender |
| | and recipient |
| r_avg_usd_network | Average network transaction amount, in |
| transaction_received | $, historically received by the recipient |
| is_s_r_state_code_ | Is network transaction sender′s and |
| same | recipient′s IP state code same |
| s_network | time difference, in seconds, between |
| transaction_date_to_ | last time of customer service call |
| last_ms_call_ | made by sender and current Pay Friends |
| time_diff | (network transaction) transaction time |
| r_account_age_in_days | Account age of recipient |
| r_no_of_network | Number of network transaction senders |
| transaction_senders_ | historically engaged by |
| engaged | current network transaction recipient |
| r_max_usd_network | Maximum network transaction amount, |
| transaction_received | in USD, recipient ever received |
| r_time_diff_bw_first_ | Time difference, in sec, b/w recipient |
| network transaction_ | first network transaction send time and |
| receive_and_current_ | current network transaction |
| network_transaction | |
| r_m_prior_useragent | recipient device month prior user agent |
| r_no_of_txns | number of transactions (any) done |
| | historically done by the network |
| | transaction recipient |
| r_usd_network | Amount, in USD, that recipient received |
| transaction_ | in last 1 day |
| receives_in_1_d | |
| r_last_txn_current_ | Time difference, in days, between recipient |
| network transaction_ | last any transaction and current |
| time_diff | network transaction |
| r_state_code | state code of the network transaction |
| s_device_model | recipient sender device model |
| s_w_prior_device_model | sender week prior device model |
| r_min_usd_network | minimum network transaction amount, in |
| transaction_received | USD, historically received by the |
| | network transaction recipient |
| r_avg_usd_network | Average network transaction amount, in $, |
| transaction_sent | historically sent by recipient |
| s_time_diff_bw_last_ | Time difference, in seconds, b/w network |
| network transaction_ | transaction sender′s last network |
| send_and_current_ | transaction send and current network |
| network_transaction | transaction |
| r_no_of_ | Number of historical network transactions |
| network transactions | involving network transaction recipient |
| s_no_of_ | Number of historical network transactions |
| network transactions | involving network transaction sender |
| s_avg_usd_network | average network transaction dollar amount, |
| transaction_sent | in USD, historically sent by network |
| | transaction sender |
| r_unique_txn_types | No of unique transaction types done by |
| network_transaction_ | recipient hour of the day sender is |
| hour | initiating the current network transaction |
| s_usd_network_ | Total network transaction sends, in USD, |
| transaction_sent | made by network transaction sender |
| r_time_diff_bw_first_ | Time difference, in seconds, between first |
| network transaction_ | network transaction send done by |
| send_and_current_ | recipient and current network transaction |
| network transaction | |
| r_usd_dds_deposited | Total direct deposits, in USD, historically |
| | received by network transaction |
| | recipient |
| r_min_usd_network | minimum network transaction amount, in |
| transaction_sent | USD, historically sent by the |
| | network transaction recipient |
| s_min_usd_network | minimum network transaction amount, in |
| transaction_sent | USD, historically sent by the |
| | network transaction sender |
| r_no_of_atm_ | Historical number of atm withdrawals |
| withdrawals | done by network transaction recipient |
| s_no_of_network | Number of historical network transaction |
| transaction_sends | sends done by network transaction sender |
| s_m_prior_os_version | sender month prior operating system version |
| s_no_of_phone_resets | Number of historical phone number resets |
| | done by network transaction sender |
| s_usd_network | Total amount, in USD, historically received |
| transaction_received | over network transaction by |
| | network transaction sender |
| s_no_of_network | Number of network transaction recipients |
| transaction_ | engaged with current network |
| recipients_engaged | transaction sender historically |
| network | day of the week of |
| transaction_day | current network transaction |
| s_no_of_tickets_in_ | Numbe of MS (customer/member service) |
| last_1_w | tickets created by network |
| | transaction recipient in last 1 week |
| r_no_of_network | Number of historical network transaction |
| transaction_sends | sends done by network transaction recipient |
| is_s_current_and_ | Is network transaction senders current and |
| w_prior_device_ | 1 week prior device model same |
| model_same | |
| r_no_of_dds | number of direct deposits received by the |
| | network transaction recipient |
| r_no_of_network | Number of network transaction sender′s |
| transaction_senders_ | current network transaction |
| engaged_in_1_d | recipient engaged in last 1 day |
| s_usd_network | Amount, in USD, of historical network |
| transactions | transactions involving network |
| | transaction sender |
| is_s_current_and_ | Is network transaction sender current and |
| w_prior_network_ | week before network carrier are same |
| carrier_same | |
| s_no_of_tickets_ | Number of MS tickets created by network |
| in_last_1_d | transaction sender in last 1 day |
| s_usd_saving_ | Total historical saving interests, in USD, |
| interests_received | received by network transaction sender |
| s_no_of_network | Number of network transaction receives |
| transaction_receives | sender got historically |
| r_no_of_phone_ | Number of historical phone number |
| resets | resets in last 12 hour made by |
| | network transaction recipient |
| r_no_of_network | Number of network transaction receives |
| transaction_ | recipient got in last 1 day |
| receives_in_1_d | |
| s_m_prior_device_ | 1 month prior seen device manufacturer |
| manufacturer | of network transaction sender |
| r_traffic_source | traffic source of network transaction |
| | recipient |
| s_w_prior_device_ | 1 month prior seen device manufacturer |
| manufacturer | of network transaction sender |
| s_unique_ticket_ | No of unique MS ticket contact groups |
| groups_in_last_1_w | made by network transaction |
| | sender in last 1 week |
| s_no_of_saving_ | Number of historical saving interests |
| interests_received | received by network transaction sender |
| s_device_ | Device manufacturer of the network |
| manufacturer | transaction sender |
| s_no_of_email_ | Number of email resets done by network |
| resets_in_1_d | transaction sender in last 1 day |
| s_no_of_phone_ | Number of phone number resets in last 1 |
| resets_in_1_d | day made by network transaction sender |
| r_no_of_round_ups | Number of historical round ups made |
| | by network transaction recipient |
| r_no_of_saving_to_ | Number of historical saving to checking |
| checking_transfers | transfer done by network |
| | transaction recipient |
| s_no_of_account_ | Number of account update profile calls |
| update_profile_calls_ | made by network transaction sender |
| in_last_1_w | in last 1 week |
| r_usd_utility_paid | Total amount, in USD, paid by network |
| | transaction recipient in |
| | utility bills historically |
| s_no_of_network | Number of senders historically transacted |
| transaction_senders | with network transaction sender |
| s_no_of_email_ | Number of historical email resets done by |
| resets_in_1_w | network transaction sender in last 1 week |
| r_no_of_checking_to_ | Number of historical checking to saving |
| saving_transfers | transfers done by network transaction |
| | recipient |
| r_device_ | Device manufacturer of network |
| manufacturer | transaction recipient |
| r_usd_payroll_ | Total payroll deposits, in USD, received |
| deposits | by network transaction recipient |
| s_no_of_email_ | Number of email resets done by the sender |
| resets_in_12_h | in last 12 hour |
| s_w_prior_os_name | sender device′s week prior operating |
| | system name |
| r_w_prior_ | recipient week prior device |
| device_manufacturer | manufacturer |
| r_no_of_utility_ | Number of historical utililty payments |
| payments | done by network transaction recipient |
| s_device_type | Device type of network transaction sender |
| s_os_name | sender device operating system name |
| r_device_type | device type of current network transaction |
| | recipient |
| r_no_of_payroll_ | Number of historical payroll deposits |
| deposits | received by network transaction recipient |
| r_os_name | recipient device operating system name |
| r_usd_network | Total amount, in USD, of network |
| transaction_sends_ | transaction sends done by network |
| in_1_d | transaction recipient in last 1 day |
| is_s_first_network | Is the current network transaction send the |
| transaction_send | sender′s first network transaction send |
| s_m_prior_os_name | sender device′s month prior operating |
| | system name |
| r_w_prior_os_name | recipient device′s week prior operating |
| | system name |
| no_of_network | Number of historical network transaction |
| transaction_received_ | receives the current network transaction |
| from_same_r | sender made to same recipient |
| r_no_of_phone_ | Number of phone number resets in last |
| resets_in_1_w | 1 week made by network |
| | transaction recipient |
| is_first_network | If current network transaction is the |
| transaction_ | first network transaction receive |
| receive_for_r | for the recipient |
| is_s_current_and_ | is network transaction sender′s current |
| m_prior_network_ | device network carrier and month prior |
| carrier_same | device network carrier the same |
| is_s_current_and_ | is network transaction sender′s current |
| m_prior_device_ | device model and month prior |
| model_same | device model the same |
| s_no_of_phone_ | Number of phone number resets in last 2 |
| resets_in_2_h | hours made by network transaction sender |
| r_no_of_tickets_ | Numbe of MS tickets created by network |
| in_last_1_w | transaction recipient in last 1 week |
| is_s_referred | Did network transaction sender join |
| | chime via referral |
| r_unique_ticket_ | Number of MS tickets created by network |
| groups_in_last_1_w | transaction recipient in last 1 week |
| is_s_current_and_ | is network transaction sender′s current |
| m_prior_os_version_ | device operating system version and month |
| same | prior device operating system version |
| | the same |
| r_m_prior_os_name | recipient device month prior operating |
| | system name |
| is_r_referred | Did network transaction recipient join chime |
| | via referral |
| is_s_r_zipcode_same | If sender and recipient zipcode |
| is_s_current_ | same is network transaction sender |
| and_w_prior_ | device current user agent and |
| useragent_same | week prior device user agent the same |
| is_r_current_and_ | is network transaction recipient device |
| w_prior_user | current user agentand week prior |
| agent_same | device user agent the same |
| is_r_m_prior_ | is network transaction recipient device |
| and_w_prior_ | month prior timezone and week prior |
| timezone_same | device timezone the same |
| is_r_m_prior_and_ | is network transaction recipient device |
| w_prior_network_ | month prior network carrier and week |
| carrier_same | prior network carrier the same |
| is_r_m_prior_and_w_ | is network transaction recipient device month |
| prior_os_name_same | prior operating system name and week |
| | prior operating system name the same |
| is_r_m_prior_and_ | is network transaction recipient device |
| m_prior_device_ | model a month prior same as a week prior |
| model_same | |
| is_r_current_and_m_ | is network transaction recipient device |
| prior_os_name_same | current operating system name and month |
| | prior operating system name the same |
| is_r_current_and_ | is network transaction recipient device |
| m_prior_ | current timezone and month prior |
| timezone_same | device timezone the same |
| is_r_current_and_ | is network transaction recipient device |
| m_prior_network_ | current network carrier and month prior |
| carrier_same | network carrier the same |
| r_no_of_email_ | Number of historical email resets done |
| resets_in_1_w | by network transaction |
| | recipient in last 1 week |
| r_no_of_account_ | Number of account update profile calls |
| update_profile_ | made by network transaction recipient |
| calls | |
| is_r_current_and_ | is network transaction recipient device |
| m_prior_device_ | current device manufacturer and month |
| manufacturer_same | prior device manufacturer the same |
| is_r_last_txn_atm_w | Is last transaction type of network transaction |
| | recipient an ATM withdrawal |
| is_r_current_and_ | is network transaction recipient device current |
| m_prior_os_ | operating system version and month prior |
| version_same | operating system version the same |
| is_r_current_and_ | is network transaction recipient device |
| m_prior_device_ | current model and month |
| model_same | prior model the same |
| is_s_current_and_ | is network transaction sender device |
| m_prior_user | current user agent and month prior |
| agent_same | device user agent the same |
| is_r_current_ | is network transaction recipient device |
| and_m_prior_user | current user agent and month |
| agent_same | prior device user agent the same |
| is_s_first_txn_ | Is first transaction of network transaction |
| network transaction_ | sender a network transaction |
| receive | receive transaction |
| time_diff_bw_first_ | Time difference, in seconds, between first |
| network transaction_ | network transaction receive from same |
| receive_from_same_ | recipient and current network transaction |
| r_and_current_ | |
| network transaction | |
| r_no_of_referrals_ | Number of histotical referrals converted |
| converted_to_bonus | to bonus by network |
| | transaction recipient |
| is_r_referred_by_s | Did network transaction recipient join |
| | Chime by referral from |
| | network transaction sender |
| usd_network | Total network transaction amount, in |
| transaction_received_ | USD, network transaction sender |
| from_same_r | historically received from same |
| | recipient |
| max_usd_network | maximum network transaction amount, |
| transaction_received_ | in USD, network transaction sender |
| from_same_r | historically received from same recipient |
| r_no_of_phone_ | Number of phone number resets in last |
| resets_in_1_d | 1 day made by network |
| | transaction recipient |
| avg_usd_network | Average network transaction amount, |
| transaction_received_ | in USD, network transaction sender |
| from_same_r | historically received from same |
| | recipient |
| r_no_of_phone_ | Number of phone number resets in |
| resets_in_12_h | last 12 hours made by network |
| | transaction recipient |
| time_diff_bw_last_ | Time difference, in seconds, between last |
| network transaction_ | network transaction receive to same |
| receive_from_same_ | recipient and current network transaction |
| r_and_current_ | |
| network transaction | |
| r_usd_atm_ | amount, in USD, network transaction |
| withdrawn_ | recipient withdrawn from ATM |
| in_1_d | |
| is_s_r_address_same | is network transaction sender address |
| | the same as network transaction |
| | recipient address |
| r_no_of_account_ | Number of account update profile calls |
| update_profile_calls_ | made by network transaction |
| in_last_1_w | recipient in last 1 week |
| r_no_of_ | Number of atm withdrawals done by |
| atm_withdrawals_ | network transaction recipient in last 1 day |
| in_1_d | |
| is_s_referred_by_r | Did network transaction sender join Chime |
| | by referral from network |
| | transaction recipient |

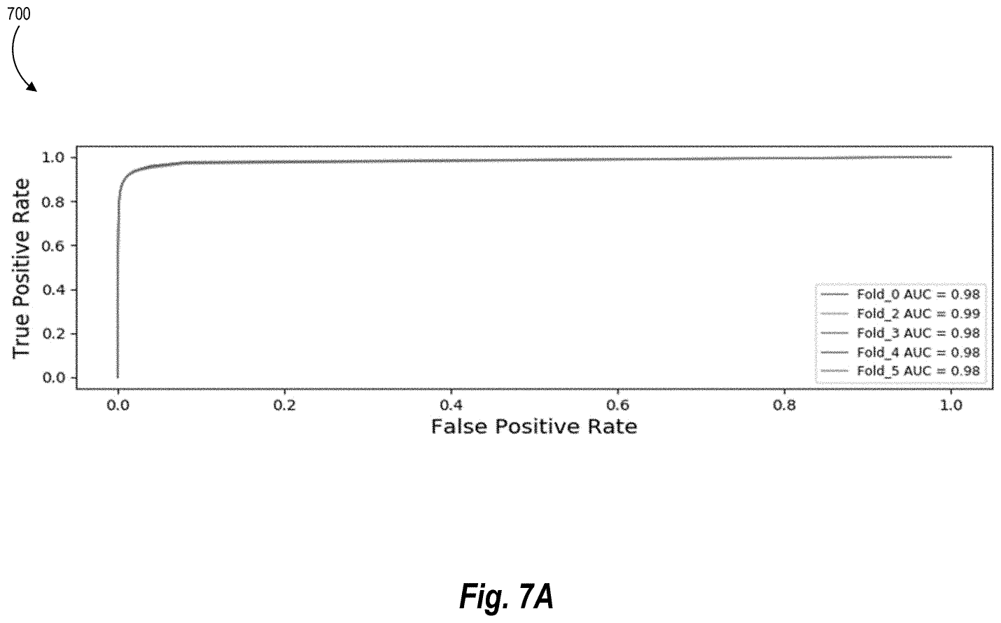

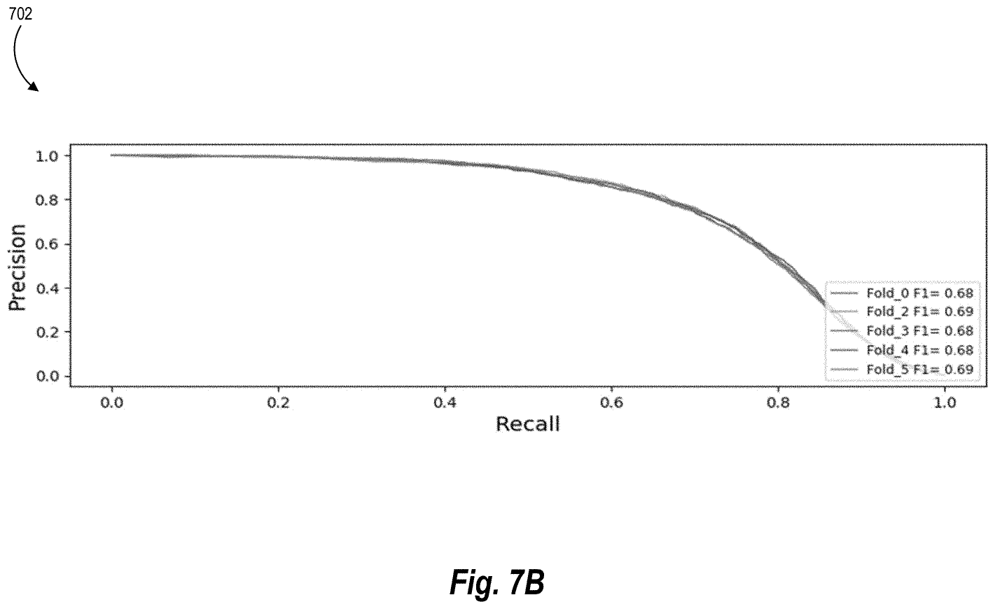

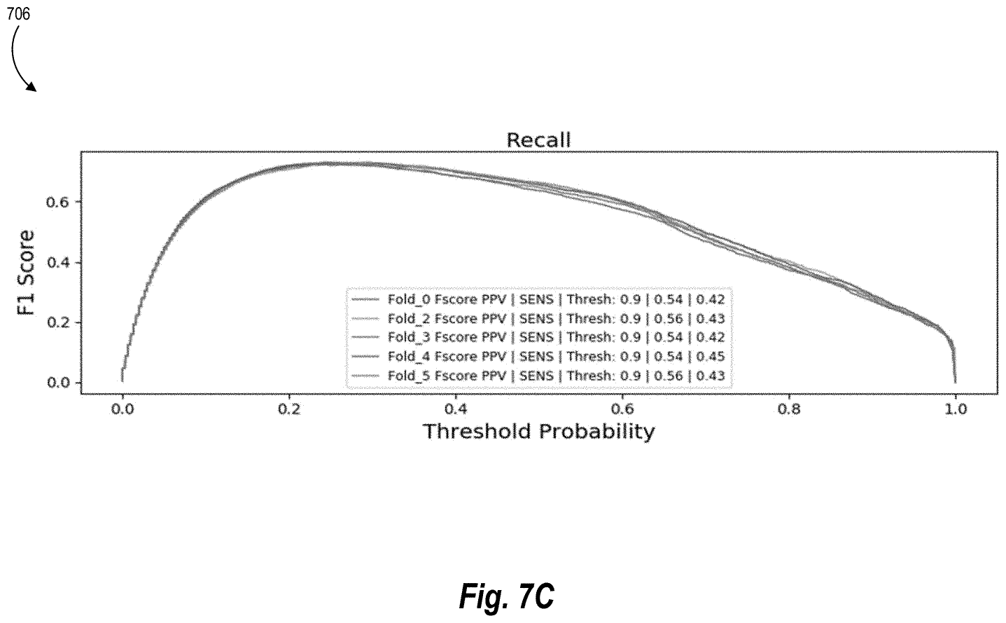

As discussed above, the fraud detection system 102 can efficiently and accurately generate a fraud prediction in real time (or near real time). FIGS. 7A-7C illustrate graphs of various accuracy metrics for fraud predictions by the fraud detection system 102 using a fraud detection machine-learning model in accordance with one or more embodiments. As indicated by FIGS. 7A-7C, experimenters used an embodiment of the disclosed fraud detection machine-learning model to determine fraud predictions for a testing set of network transactions and compared the fraud predictions to a corresponding set of ground truth identifiers. Based on the comparison of fraud predictions and corresponding ground truth identifiers, the experimenters determined true positive rates and false positive rates for predicting fraudulent network transactions, precision and recall for predicting fraudulent network transactions, and F1 scores for predicting fraudulent network transactions. As shown in each of FIGS. 7A-7C, the fold curves for k-fold cross validation overlap in a substantially consistent or smooth manner and thereby demonstrate consistency.

In particular, FIG. 7A shows a graph 700 indicating a true positive rate (Y-axis) versus a false positive rate (X-axis) for fraud predictions. Specifically, experimenters determined that each of folds 1-5 provided an AUC (area under curve) score of about 98% or 99%. As indicated by FIG. 7A, the fraud detection system 102 uses a fraud detection machine-learning model that generates fraud predictions for network transactions with highly accurate true positive and false positive rates.

In FIG. 7B, a graph 702 indicates precision (Y-axis) versus recall (X-axis) of fraud predictions. The graph 702 indicates that folds 1-5 correspond to an average F1 score of about 68% to about 69%. As indicated by FIG. 7A, the fraud detection system 102 uses a fraud detection machine-learning model that generates fraud predictions for network transactions with balanced and accurate precision and recall.

Additionally, in FIG. 7C, a graph 706 indicates an F1 score (Y-axis) versus a threshold probability value (X-axis). In particular, the graph 706 indicates folds 1-5 produce an average recall of about 54% to about 56%.

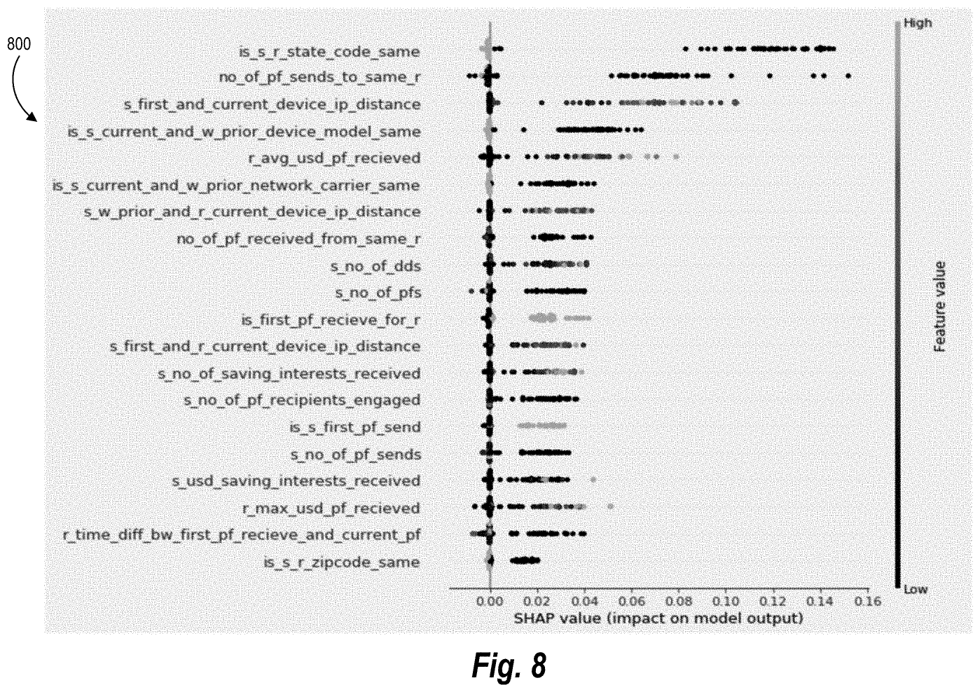

FIG. 8 illustrates an additional graph depicting an importance of various features used by the fraud detection system 102 for the fraud detection machine-learning model 308 in accordance with one or more embodiments. In particular, FIG. 8 shows a graph 800 indicating Shapley values for a set of features corresponding to network transactions. As the graph 800 indicates, some features have more impact on the fraud detection machine-learning model 308 than other features. As indicated by FIG. 8, unlike conventional network-transaction-security systems, the fraud detection system 102 can use the fraud detection machine-learning model 308 to identify more important features to accurately predicting whether an initiated network transaction is fraudulent or legitimate.

For example, congruency of state codes between the sender device and recipient device (denoted as “is_s_r_state_code_same”) has a larger impact on the fraud detection machine-learning model 308 in generating a fraud prediction compared to other features. By contrast, congruency of zip codes between the sender device and recipient device (denoted as “is_s_r_zipcode_same”) has a comparatively smaller impact on the fraud detection machine-learning model 308 in generating a fraud prediction. These and other feature-model interactions are quantitatively plotted in the graph 800.

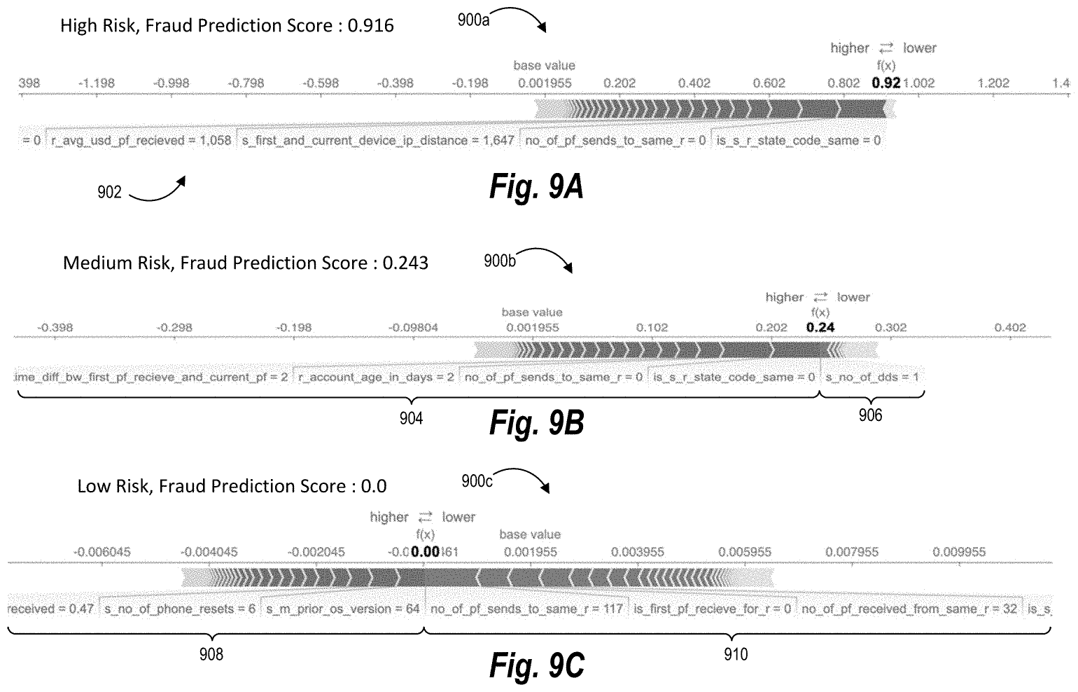

As discussed above, the fraud detection system 102 can generate fraud prediction scores that indicate different probability levels of fraud for a network transaction. FIGS. 9A-9C illustrate examples of different fraud prediction scores in accordance with one or more embodiments. In particular, FIG. 9A illustrates a score plot 900a for a set of features 902. Specifically, based on the set of features 902 corresponding to a network transaction, the fraud detection system 102 utilizes the fraud detection machine-learning model 308 to generate a high-risk fraud prediction score of 0.916.

In contrast, FIG. 9B illustrates a score plot 900b for a set of features 904 and a set of features 906 for a different network transaction. In particular, the fraud detection system 102 utilizes the fraud detection machine-learning model 308 to generate a medium risk fraud prediction score of 0.243 based on the set of features 904 and the set of features 906. Specifically, the set of features 904 indicate a network transaction is likely fraudulent, while the set of features 906 indicate the network transaction is likely not fraudulent. However, the fraud detection machine-learning model 308 collectively weights the set of features 904 more heavily than the set of features 906. As a result, the fraud detection machine-learning model 308 generates a medium risk fraud prediction score.

Further, FIG. 9C illustrates a score plot 900c for a set of features 908 and a set of features 910. As shown in FIG. 9C, the set of features 908 indicate an additional network transaction is likely fraudulent, and the set of features 910 indicate the additional network transaction is likely not fraudulent. However, unlike FIGS. 9A-9B, the fraud detection machine-learning model 308 weights the set of features 908 and the set of features 910 with approximately equivalent importance. Indeed, based on the set of features 908 and the set of features 910, the fraud detection system 102 generates a low-risk fraud prediction score of 0.0.

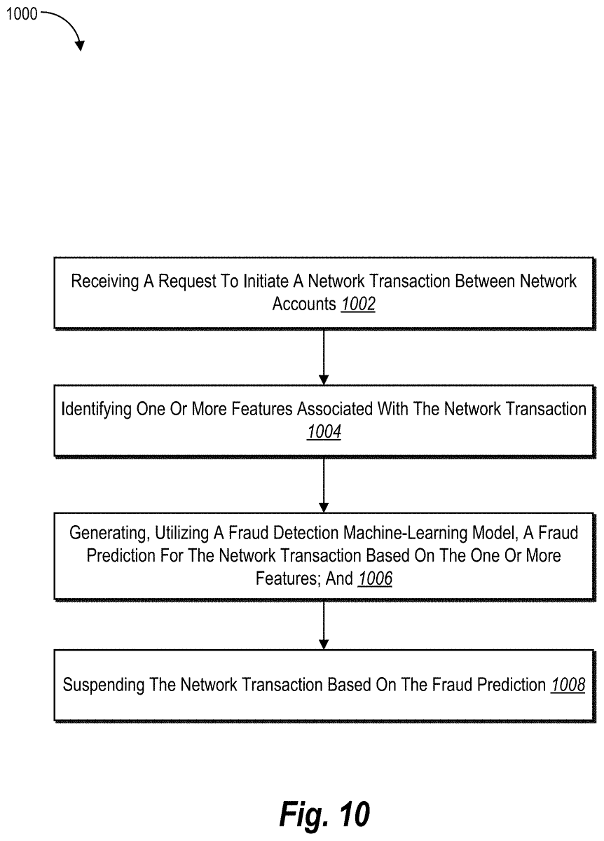

FIGS. 1-9C, the corresponding text, and the examples provide several different systems, methods, techniques, components, and/or devices of the fraud detection system 102 in accordance with one or more embodiments. In addition to the above description, one or more embodiments can also be described in terms of flowcharts including acts for accomplishing a particular result. For example, FIG. 10 illustrates a flowchart of a series of acts 1000 for generating a fraud prediction in accordance with one or more embodiments. The fraud detection system 102 may perform one or more acts of the series of acts 1000 in addition to or alternatively to one or more acts described in conjunction with other figures. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer-readable medium can comprise instructions that, when executed by one or more processors, cause a computing device to perform the acts of FIG. 10. In some embodiments, a system can perform the acts of FIG. 10.

As shown in FIG. 10, the series of acts 1000 includes an act 1002 of receiving a request to initiate a network transaction between network accounts. In addition, the series of acts 1000 includes an act 1004 of identifying one or more features associated with the network transaction. The series of acts 1000 further includes an act 1006 of generating, utilizing a fraud detection machine-learning model, a fraud prediction for the network transaction based on the one or more features. Additionally, the series of acts 1000 includes an act 1008 of suspending the network transaction based on the fraud prediction.

It is understood that the outlined acts in the series of acts 1000 are only provided as examples, and some of the acts may be optional, combined into fewer acts, or expanded into additional acts without detracting from the essence of the disclosed embodiments. Additionally, the series of acts 1000 described herein may be repeated or performed in parallel with one another or in parallel with different instances of the same or similar acts. As an example of an additional act not shown in FIG. 10, act(s) in the series of acts 1000 may include an act of identifying the one or more features associated with the network transaction by identifying at least one of transaction data, sender account historical data, sender device data, recipient account historical data, recipient device data, customer-service-contact data, payment schedule data, new-account-referral data, or historical-sender-recipient-account interactions.

As another example of an additional act not shown in FIG. 10, act(s) in the series of acts 1000 may include an act of generating the fraud prediction by: weighting the one or more features in a plurality of decision trees; determining a plurality of fraud predictions corresponding to the plurality of decision trees; and combining the plurality of fraud predictions from the plurality of decision trees.

As a further example of an additional act not shown in FIG. 10, act(s) in the series of acts 1000 may include an act of transmitting a verification request to a client device associated with one of the network accounts after suspension of the network transaction.

In still another example of an additional act not shown in FIG. 10, act(s) in the series of acts 1000 may include an act of transmitting the verification request comprising at least one of an identification-document scan, a live-image-capture request of at least a face, or a biometric scan for verifying an identity of a user corresponding to one of the network accounts.

Additionally, another example of an additional act not shown in FIG. 10 includes act(s) in the series of acts 1000 of: receiving a verification response to the verification request that verifies an identity of a user corresponding to one of the network accounts; and approving the network transaction based on the verification response.

As another example of an additional act not shown in FIG. 10, act(s) in the series of acts 1000 may include an act of: generating the fraud prediction by generating a fraud prediction score; and transmitting the verification request to the client device by transmitting one of: a first type of verification request based on the fraud prediction score satisfying a first threshold fraud prediction score; or a second type of verification request based on the fraud prediction score satisfying a second threshold fraud prediction score.

In yet another example of an additional act not shown in FIG. 10, act(s) in the series of acts 1000 may include an act of generating the fraud prediction by generating an account-take-over score indicating a probability of an account take over associated with the network transaction, a first-party-fraud score indicating a probability of first party fraud associated with the network transaction, and a suspicious-activity score indicating a probability of suspicious activity associated with the network transaction.

In a further example of an additional act not shown in FIG. 10, act(s) in the series of acts 1000 may include an act of receiving the request to initiate the network transaction by receiving a particular request to initiate a peer-to-peer transaction between a sender account and a recipient account.

Additionally, in another example of an additional act not shown in FIG. 10, act(s) in the series of acts 1000 may include an act of identifying the one or more features associated with the network transaction by identifying at least one of: an average transaction amount that a recipient account of the network accounts receives from sender accounts via peer-to-peer network transactions; a geographical region associated with a sender account of the network accounts and the recipient account; or a number of historical deposits associated with the sender account.

In yet another example of an additional act not shown in FIG. 10, act(s) in the series of acts 1000 may include an act of identifying the one or more features associated with the network transaction by identifying at least one of: a first internet protocol (IP) address distance between a historical IP address of an initial sender device historically corresponding to a sender account of the network accounts and a current IP address of a current sender device corresponding to the sender account that requests initiation of the network transaction; a second IP address distance between the historical IP address of the initial sender device and a recipient IP address of a recipient device corresponding to a recipient account of the network accounts for the network transaction; a third IP address distance between the current IP address of the current sender device and the recipient IP address of the recipient device; or a fourth IP address distance between a recent IP address of a sender device used one week prior to requesting initiation of the network transaction and the recipient IP address of the recipient device.

In a further example of an additional act not shown in FIG. 10, act(s) in the series of acts 1000 may include an act of generating the fraud prediction for the network transaction by utilizing a random forest machine-learning model as the fraud detection machine-learning model to: generate a plurality of fraud prediction scores for the network transaction; generate a combined fraud prediction score by averaging the plurality of fraud prediction scores; and generate the fraud prediction based on the combined fraud prediction score satisfying a fraud score threshold.

In still another example of an additional act not shown in FIG. 10, act(s) in the series of acts 1000 may include an act of denying the network transaction and suspending an associated network transaction based on the fraud prediction for the network transaction.

In particular embodiments, an additional act not shown in FIG. 10 includes act(s) in the series of acts 1000 of: identifying a precision metric threshold or a recall metric threshold for generated fraud predictions based on a collective target value for fraud-claim reimbursements; determining a loss of the fraud detection machine-learning model based on the fraud prediction; and updating one or more parameters of the fraud detection machine-learning model based on the loss and at least one of the precision metric threshold or the recall metric threshold.

In another example of an additional act not shown in FIG. 10, act(s) in the series of acts 1000 may include an act of suspending at least one of the network accounts based on the fraud prediction.

In yet another example of an additional act not shown in FIG. 10, act(s) in the series of acts 1000 may include an act of identifying the one or more features by identifying at least one of IP-distance-based features, a geographical region associated with the network accounts, an average transaction amount that a recipient account of the network accounts receives from sender accounts via peer-to-peer network transactions, or a number of historical deposits associated with a sender account of the network accounts.

In a further example of an additional act not shown in FIG. 10, act(s) in the series of acts 1000 may include an act of transmitting a verification request to a client device associated with one of the network accounts after suspension of the network transaction, the verification request comprising at least one of an identification-document scan, a live-image-capture request of at least a face, or a biometric scan for verifying an identity of a user corresponding to one of the network accounts.

In still another example of an additional act not shown in FIG. 10, act(s) in the series of acts 1000 may include an act of denying the network transaction based on one of: failing to receive a verification response to the verification request; or receiving a verification response to the verification request that fails to verify an identity of a user corresponding to one of the network accounts.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 (e.g., the client device(s) 110a-110n, the administrator device 114, and/or the server(s) 106) that may be configured to perform one or more of the processes described above. As shown by FIG. 11, the computing device can comprise a processor 1102, memory 1104, a storage device 1106, an I/O interface 1108, and a communication interface 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, storage device 1106 can comprise a non-transitory storage medium described above. The storage device 1106 may include a hard disk drive (“HDD”), flash memory, a Universal Serial Bus (“USB”) drive or a combination of these or other storage devices.

The computing device 1100 also includes one or more input or output interface 1108 (or “I/O interface 1108”), which are provided to allow a user (e.g., requester or provider) to provide input to (such as user strokes), receive output from, and otherwise transfer data to and from the computing device 1100. The I/O interface 1108 may include a mouse, keypad or a keyboard, a touch screen, camera, optical scanner, network interface, modem, other known I/O devices or a combination of such I/O interface 1108. The touch screen may be activated with a stylus or a finger.

The I/O interface 1108 may include one or more devices for presenting output to a user, including, but not limited to, a graphics engine, a display (e.g., a display screen), one or more output providers (e.g., display providers), one or more audio speakers, and one or more audio providers. In certain embodiments, interface 1108 is configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices 1100 or one or more networks. As an example, and not by way of limitation, communication interface 1110 may include a network interface controller (“NIC”) or network adapter for communicating with an Ethernet or other wire-based network or a wireless NIC (“WNIC”) or wireless adapter for communicating with a wireless network, such as a WI-FI. The computing device 1100 can further include a bus 1112. The bus 1112 can comprise hardware, software, or both that connects components of computing device 1100 to each other.

FIG. 12 illustrates an example network environment 1200 of the inter-network facilitation system 104. The network environment 1200 includes a client device 1206 (e.g., client device 110a-110n), an inter-network facilitation system 104, and a third-party system 1208 connected to each other by a network 1204. Although FIG. 12 illustrates a particular arrangement of the client device 1206, the inter-network facilitation system 104, the third-party system 1208, and the network 1204, this disclosure contemplates any suitable arrangement of client device 1206, the inter-network facilitation system 104, the third-party system 1208, and the network 1204. As an example, and not by way of limitation, two or more of client device 1206, the inter-network facilitation system 104, and the third-party system 1208 communicate directly, bypassing network 1204. As another example, two or more of client device 1206, the inter-network facilitation system 104, and the third-party system 1208 may be physically or logically co-located with each other in whole or in part.

Moreover, although FIG. 12 illustrates a particular number of client devices 1206, inter-network facilitation systems 104, third-party systems 1208, and networks 1204, this disclosure contemplates any suitable number of client devices 1206, inter-network facilitation system 104, third-party systems 1208, and networks 1204. As an example, and not by way of limitation, network environment 1200 may include multiple client device 1206, inter-network facilitation system 104, third-party systems 1208, and/or networks 1204.

This disclosure contemplates any suitable network 1204. As an example, and not by way of limitation, one or more portions of network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1204 may include one or more networks 1204.

Links may connect client device 1206, fraud detection system 102, and third-party system 1208 to network 1204 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by client device 1206. As an example, and not by way of limitation, a client device 1206 may include any of the computing devices discussed above in relation to FIG. 11. A client device 1206 may enable a network user at the client device 1206 to access network 1204. A client device 1206 may enable its user to communicate with other users at other client devices 1206.

In particular embodiments, the client device 1206 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1206 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1206 one or more Hyper Text Markup Language (“HTML”) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1204) to link the third-party-system 1208. For example, the inter-network facilitation system 104 may receive authentication credentials from a user to link a third-party system 1208 such as an online bank account, credit account, debit account, or other financial account to a user account within the inter-network facilitation system 104. The inter-network facilitation system 104 can subsequently communicate with the third-party system 1208 to detect or identify balances, transactions, withdrawal, transfers, deposits, credits, debits, or other transaction types associated with the third-party system 1208. The inter-network facilitation system 104 can further provide the aforementioned or other financial information associated with the third-party system 1208 for display via the client device 1206. In some cases, the inter-network facilitation system 104 links more than one third-party system 1208, receiving account information for accounts associated with each respective third-party system 1208 and performing operations or transactions between the different systems via authorized network connections.

In particular embodiments, the inter-network facilitation system 104 may interface between an online banking system and a credit processing system via the network 1204. For example, the inter-network facilitation system 104 can provide access to a bank account of a third-party system 1208 and linked to a user account within the inter-network facilitation system 104. Indeed, the inter-network facilitation system 104 can facilitate access to, and transactions to and from, the bank account of the third-party system 1208 via a client application of the inter-network facilitation system 104 on the client device 1206. The inter-network facilitation system 104 can also communicate with a credit processing system, an ATM system, and/or other financial systems (e.g., via the network 1204) to authorize and process credit charges to a credit account, perform ATM transactions, perform transfers (or other transactions) across accounts of different third-party systems 1208, and to present corresponding information via the client device 1206.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1208), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1200 either directly or via network 1204. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1204.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1206. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from client device 1206 responsive to a request received from client device 1206. Authorization servers may be used to enforce one or more privacy settings of the users of the inter-network facilitation system 104. A privacy setting of a user determines how particular information associated with a user can be shared. The authorization server may allow users to opt into or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1206 associated with users.

In addition, the third-party system 1208 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1204. A third-party system 1208 can communicate with the inter-network facilitation system 104 to provide financial information pertaining to balances, transactions, and other information, whereupon the inter-network facilitation system 104 can provide corresponding information for display via the client device 1206. In particular embodiments, a third-party system 1208 communicates with the inter-network facilitation system 104 to update account balances, transaction histories, credit usage, and other internal information of the inter-network facilitation system 104 and/or the third-party system 1208 based on user interaction with the inter-network facilitation system 104 (e.g., via the client device 1206). Indeed, the inter-network facilitation system 104 can synchronize information across one or more third-party systems 1208 to reflect accurate account information (e.g., balances, transactions, etc.) across one or more networked systems, including instances where a transaction (e.g., a transfer) from one third-party system 1208 affects another third-party system 1208.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium comprising instructions that, when executed by at least one processor, cause a computing device to:
receive a request to initiate a network transaction between network accounts;
identify one or more features associated with the network transaction;
generate, utilizing a fraud detection machine-learning model, a fraud prediction for the network transaction based on the one or more features; and
suspend the network transaction based on the fraud prediction.

2. The non-transitory computer-readable medium of claim 1, further comprising instructions that, when executed by the at least one processor, cause the computing device to identify the one or more features associated with the network transaction by identifying at least one of transaction data, sender account historical data, sender device data, recipient account historical data, recipient device data, customer-service-contact data, payment schedule data, new-account-referral data, or historical-sender-recipient-account interactions.

3. The non-transitory computer-readable medium of claim 1, further comprising instructions that, when executed by the at least one processor, cause the computing device to generate the fraud prediction by:
weighting the one or more features in a plurality of decision trees;
determining a plurality of fraud predictions corresponding to the plurality of decision trees; and
combining the plurality of fraud predictions from the plurality of decision trees.

4. The non-transitory computer-readable medium of claim 1, further comprising instructions that, when executed by the at least one processor, cause the computing device to transmit a verification request to a client device associated with one of the network accounts after suspension of the network transaction.

5. The non-transitory computer-readable medium of claim 4, further comprising instructions that, when executed by the at least one processor, cause the computing device to transmit the verification request comprising at least one of an identification-document scan, a live-image-capture request of at least a face, or a biometric scan for verifying an identity of a user corresponding to one of the network accounts.

6. The non-transitory computer-readable medium of claim 4, further comprising instructions that, when executed by the at least one processor, cause the computing device to:
receive a verification response to the verification request that verifies an identity of a user corresponding to one of the network accounts; and
approve the network transaction based on the verification response.

7. The non-transitory computer-readable medium of claim 4, further comprising instructions that, when executed by the at least one processor, cause the computing device to:
generate the fraud prediction by generating a fraud prediction score; and
transmit the verification request to the client device by transmitting one of:
a first type of verification request based on the fraud prediction score satisfying a first threshold fraud prediction score; or
a second type of verification request based on the fraud prediction score satisfying a second threshold fraud prediction score.

8. The non-transitory computer-readable medium of claim 1, further comprising instructions that, when executed by the at least one processor, cause the computing device to generate the fraud prediction by generating an account-take-over score indicating a probability of an account take over associated with the network transaction, a first-party-fraud score indicating a probability of first party fraud associated with the network transaction, and a suspicious-activity score indicating a probability of suspicious activity associated with the network transaction.

9. A system comprising:
at least one processor; and
at least one non-transitory computer-readable storage medium storing instructions that, when executed by the at least one processor, cause the system to:
receive a request to initiate a network transaction between network accounts;
identify one or more features associated with the network transaction;
generate, utilizing a fraud detection machine-learning model, a fraud prediction for the network transaction based on the one or more features; and
suspend the network transaction based on the fraud prediction.

10. The system of claim 9, further comprising instructions that, when executed by the at least one processor, cause the system to receive the request to initiate the network transaction by receiving a particular request to initiate a peer-to-peer transaction between a sender account and a recipient account.

11. The system of claim 9, further comprising instructions that, when executed by the at least one processor, cause the system to identify the one or more features associated with the network transaction by identifying at least one of:
an average transaction amount that a recipient account of the network accounts receives from sender accounts via peer-to-peer network transactions;
a geographical region associated with a sender account of the network accounts and the recipient account; or
a number of historical deposits associated with the sender account.

12. The system of claim 9, further comprising instructions that, when executed by the at least one processor, identify the one or more features associated with the network transaction by identifying at least one of:
a first internet protocol (IP) address distance between a historical IP address of an initial sender device historically corresponding to a sender account of the network accounts and a current IP address of a current sender device corresponding to the sender account that requests initiation of the network transaction;
a second IP address distance between the historical IP address of the initial sender device and a recipient IP address of a recipient device corresponding to a recipient account of the network accounts for the network transaction;
a third IP address distance between the current IP address of the current sender device and the recipient IP address of the recipient device; or
a fourth IP address distance between a recent IP address of a sender device used one week prior to requesting initiation of the network transaction and the recipient IP address of the recipient device.

13. The system of claim 9, further comprising instructions that, when executed by the at least one processor, cause the system to generate the fraud prediction for the network transaction by utilizing a random forest machine-learning model as the fraud detection machine-learning model to:
generate a plurality of fraud prediction scores for the network transaction;
generate a combined fraud prediction score by averaging the plurality of fraud prediction scores; and
generate the fraud prediction based on the combined fraud prediction score satisfying a fraud score threshold.

14. The system of claim 9, further comprising instructions that, when executed by the at least one processor cause the system to deny the network transaction and suspend an associated network transaction based on the fraud prediction for the network transaction.

15. The system of claim 9, further comprising instructions that, when executed by the at least one processor, cause the system to:
identify a precision metric threshold or a recall metric threshold for generated fraud predictions based on a collective target value for fraud-claim reimbursements;
determine a loss of the fraud detection machine-learning model based on the fraud prediction; and
update one or more parameters of the fraud detection machine-learning model based on the loss and at least one of the precision metric threshold or the recall metric threshold.

16. A computer-implemented method comprising:
receiving a request to initiate a network transaction between network accounts;
identifying one or more features associated with the network transaction;
generating, utilizing a fraud detection machine-learning model, a fraud prediction for the network transaction based on the one or more features; and
suspending the network transaction based on the fraud prediction.

17. The computer-implemented method of claim 16, further comprising suspending at least one of the network accounts based on the fraud prediction.

18. The computer-implemented method of claim 16, wherein identifying the one or more features comprises identifying at least one of IP-distance-based features, a geographical region associated with the network accounts, an average transaction amount that a recipient account of the network accounts receives from sender accounts via peer-to-peer network transactions, or a number of historical deposits associated with a sender account of the network accounts.

19. The computer-implemented method of claim 16, further comprising transmitting a verification request to a client device associated with one of the network accounts after suspension of the network transaction, the verification request comprising at least one of an identification-document scan, a live-image-capture request of at least a face, or a biometric scan for verifying an identity of a user corresponding to one of the network accounts.

20. The computer-implemented method of claim 19, further comprising denying the network transaction based on one of:
failing to receive a verification response to the verification request; or
receiving a verification response to the verification request that fails to verify an identity of a user corresponding to one of the network accounts.
